(19) United States
(12) Patent Application Publication
(10) Pub. No.: US 2006/0204019 A1
(43) Pub. Date: Sep. 14, 2006

(54) Acoustic signal processing apparatus, acoustic signal processing method, acoustic signal processing program, and computer-readable recording medium recording acoustic signal processing program

(76) Inventors: Kaoru Suzuki, Yokohama-shi (JP); Toshiyuki Koga, Fuchu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/235,307

(22) Filed: Sep. 27, 2005

(30) Foreign Application Priority Data
Mar. 11, 2005 (JP) 2005-069824

(51) Int. Cl. H04R 3/00

(52) U.S. Cl. 381/92; 381/122; 381/113

(57) ABSTRACT

A frequency decomposer analyzes two amplitude data input from microphones to an acoustic signal input unit, and a two-dimensional data forming unit obtains a phase difference between the two amplitude data for each frequency. This phase difference for each frequency is given two-dimensional coordinate values to form two-dimensional data. A figure detector analyzes the generated two-dimensional data on an X-Y plane to detect a figure. A sound source information generator processes information of the detected figure to generate sound source information containing the number of sound sources as generation sources of acoustic signals, the spatial existing range of each sound source, the temporal existing period of a sound generated by each sound source, the components of each source sound, a separated sound of each sound source, and the symbolic contents of each source sound.

### CROSS-REFERENCE TO RELATED APPLICATIONS

This application is based upon and claims the benefit of priority from prior Japanese Patent Application No. 2005-069824, filed Mar. 11, 2005, the entire contents of which are incorporated herein by reference.

### BACKGROUND OF THE INVENTION

1. Field of the Invention

The present invention relates to acoustic signal processing and, more particularly, to estimation of, e.g., the number of transmission sources of sound waves propagating in a medium, the direction of each transmission source, and the frequency components of a sound wave coming from each transmission source.

2. Description of the Related Art

Recently, in the field of robot auditory sense research, a method of estimating the number and directions of a plurality of target sound sources (sound source localization) and separating and extracting each source sound (sound source separation) in a noise environment is proposed.

For example, Futoshi Asano, “Separating Sounds”, Measurement and Control, Vol. 43, No. 4, pp. 325-330, April 2004 describes a method which measures N sound sources by M microphones in an environment having background noise, generates a spatial correlation matrix from data obtained by processing each microphone output by FFT (Fast Fourier Transform), decomposes this matrix into eigenvalues to obtain large main eigenvalues, and estimates the number N of sound sources as the number of main eigenvalues. This method uses the properties that a signal having directivity such as a source sound is mapped in main eigenvalues, and background noise having no directivity is mapped in all eigenvalues. Eigenvectors corresponding to main eigenvalues are base vectors of a signal partial space spread by a signal from a sound source, and eigenvectors corresponding to the rest of eigenvalues are base vectors of a noise partial space spread by a background noise signal. The position vector of each sound source can be searched for by applying the MUSIC method by using the base vectors of the noise partial space. A sound from the found sound source can be extracted by a beam former given directivity in the direction obtained by the search. However, if the number N of sound sources is the same as the number M of microphones, no noise partial space can be defined. Also, if the number N of sound sources exceeds M, undetectable sound sources exist. Accordingly, the number of sound sources which can be estimated is less than the number M of microphones. This method does not particularly impose any large limitation on sound sources, and is also mathematically beautiful. However, to handle a large number of sound sources, more microphones than the sound sources are necessary.

Also, Kazuhiro Nakadai et al., “Real-time Active Person Tracking by Hierarchical Integration of Audiovisual Information”, Artificial Intelligence Society AI Challenge Research Meeting, SIG-Challenge-0113-5, pp. 35-42, June 2001 describes a method which performs sound source localization and sound source separation by using one microphone. This method is based on a harmonic structure (a frequency structure made up of a fundamental frequency and its harmonics) unique to a sound, such as a human voice, generated through a tube (articulator). In this method, harmonic structures having different fundamental frequencies are detected from data obtained by Fourier-transforming sound signals picked up by a microphone. The number of the detected harmonic structures is used as the number of speakers to estimate, with certainty, the direction of each harmonic structure by using its IPD (Interaural Phase Difference) and IID (Interaural Intensity Difference). In this manner, each source sound is estimated by its harmonic structure. This method can process more sound sources than microphones by detecting a plurality of harmonic structures from Fourier-transformed data. However, estimation of the number and directions of sound sources and estimation of source sounds are based on harmonic structures, so processable sound sources are limited to those having harmonic structures such as human voices. That is, the method cannot process various sounds.

As described above, there are antinomical (antinomic) problems that (1) if sound sources are not limited, the number of sound sources cannot be larger than that of microphones, and (2) if the number of sound sources is larger than that of microphones, these source sounds are limited to, e.g., harmonic structures. That is, no method capable of processing more sound sources than microphones without limiting these sound sources has been established yet.

### BRIEF SUMMARY OF THE INVENTION

The present invention has been made in consideration of the above situation, and has as its object to provide an acoustic signal processing apparatus, an acoustic signal processing method, an acoustic signal processing program, and a computer-readable recording medium recording the acoustic signal processing program for sound source localization and sound source separation which can alleviate limitations on sound sources and can process more sound sources than microphones.

An acoustic signal processing apparatus according to an aspect of the present invention comprises an acoustic signal input device configured to input a plurality of acoustic signals picked up at not less than two points which are not spatially identical, a frequency decomposing device configured to decompose each of the plurality of acoustic signals to obtain a plurality of frequency-decomposed data sets representing a phase value of each frequency, a phase difference calculating device configured to calculate a phase difference value of each frequency for a pair of different ones of the plurality of frequency-decomposed data sets, a two-dimensional data forming device configured to generate, for each pair, two-dimensional data representing dots having coordinate values on a two-dimensional coordinate system in which a function of the frequency is a first axis and a function of the phase difference value calculated by the phase difference calculating device is a second axis, a figure detecting device configured to detect, from the two-dimensional data, a figure which reflects a proportional relationship between a frequency and phase difference derived from the same sound source, a sound source information generating device configured to generate, on the basis of the figure, sound source information which contains at least one of the number of sound sources corresponding to generation sources of the acoustic signals, a spatial existing range of each sound source, a temporal existing period of a sound generated by each sound source, components of a sound generated by each sound source, a separated sound separated for each sound source, and symbolic contents of a sound generated by each sound source, and which relates to sound sources distinguished from each other, and an output device configured to output the sound source information.

### BRIEF DESCRIPTION OF THE SEVERAL VIEWS OF THE DRAWING

FIG. 1 is a functional block diagram of an acoustic signal processing apparatus according to an embodiment of the present invention;

FIGS. 2A and 2B are views showing the sound source direction and the arrival time difference observed in acoustic signals;

FIG. 3 is a view showing the relationship between frames and a frame shift amount;

FIGS. 4A to 4C are views showing the sequence of FFT and FFT data;

FIG. 5 is a functional block diagram showing the internal arrangements of a two-dimensional data formation unit and figure detector;

FIG. 6 is a view showing the sequence of phase difference calculation;

FIG. 7 is a view showing the sequence of coordinate value calculation;

FIGS. 8A and 8B are views showing the proportional relationship between the frequency and phase for the same time interval, and the proportional relationship between the phase difference and frequency for the same time difference;

FIG. 9 is a view for explaining the circularity of the phase difference;

FIGS. 10A and 10B are plots of the frequency and phase difference when a plurality of sound sources exist;

FIG. 11 is a view for explaining linear Hough transformation;

FIG. 12 is a view for explaining detection of a straight line from dots by Hough transform;

FIG. 13 is a view showing the functions (equations) of average power to be voted;

FIG. 14 is a view showing frequency components generated from an actual sound, a phase difference plot, and the results of Hough voting;

FIG. 15 is a view showing peak positions and straight lines obtained from the results of actual Hough voting;

FIG. 16 is a view showing the relationship between θ and Δρ;

FIG. 17 is a view showing frequency components generated from an actual sound, a phase difference plot, and the results of Hough voting when two persons simultaneously utter;

FIG. 18 is a view showing the results of search for peak positions performed only with votes on the θ axis;

FIG. 19 is a view showing the results of search for peak positions performed by totalizing votes in several portions separated by Δρ;

FIG. 20 is a functional block diagram showing the internal arrangement of a sound source information generator;

FIGS. 21A to 21D are views for explaining direction estimation;

FIG. 22 is a view showing the relationship between θ and ΔT;

FIGS. 23A to 23C are views for explaining sound source component estimation (a distance threshold method) when a plurality of sound sources exist;

FIG. 24 is a view for explaining a nearest neighbor method;

FIG. 25 is a view showing an example of an equation for calculating a coefficient α and its graph;

FIG. 26 is a view for explaining tracking of φ on the time axis;

FIG. 27 is a flowchart showing the flow of processing executed by the acoustic signal processing apparatus;

FIGS. 28A and 28B are views showing the relationship between the frequency and the time difference which can be expressed;

FIG. 29 is a plot of the time difference when redundant points are generated;

FIG. 30 is a functional block diagram of an acoustic signal processing apparatus according to a modification including N microphones;

FIG. 31 is a functional block diagram according to an embodiment which implements the acoustic signal processing function according to the present invention by using a general-purpose computer; and

FIG. 32 is a view showing an embodiment of a recording medium recording a program for implementing the acoustic signal processing function according to the present invention.

### DETAILED DESCRIPTION OF THE INVENTION

An embodiment of an acoustic signal processing apparatus according to the present invention will be described below with reference to the accompanying drawing.

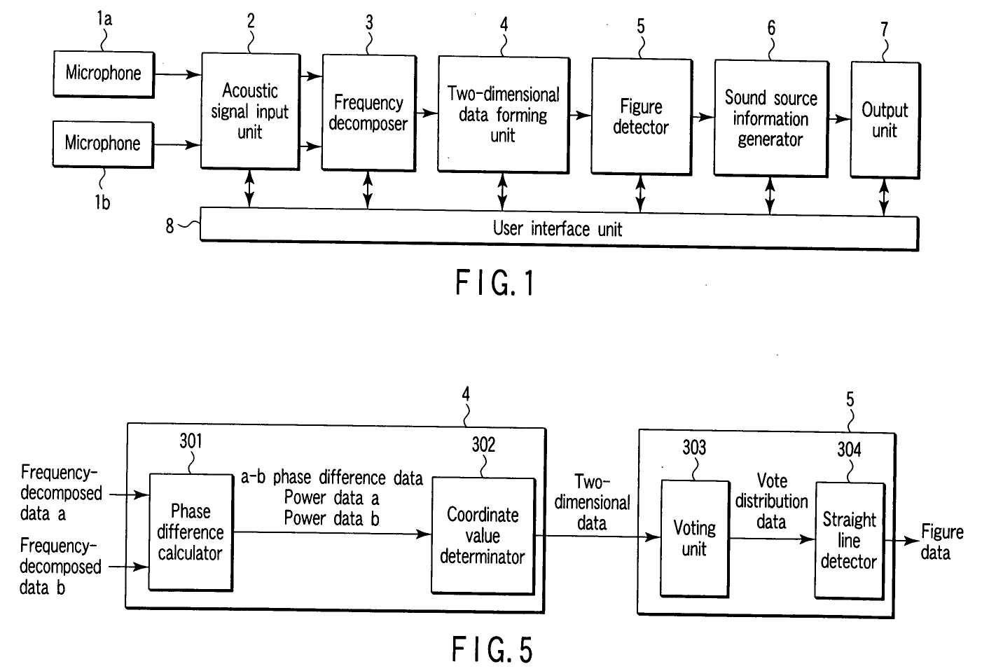

FIG. 1 is a functional block diagram of an acoustic signal processing apparatus according to an embodiment of the present invention. This acoustic signal processing apparatus comprises a microphone 1a, microphone 1b, acoustic signal input unit 2, frequency decomposer 3, two-dimensional data formation unit 4, figure detector 5, sound source information generator 6, output unit 7, and user interface unit 8.

[Basic Concept of Sound Source Estimation Based on Phase Difference of Each Frequency Component]

The microphones 1a and 1b are two microphones spaced at a predetermined distance in a medium such as air. The microphones 1a and 1b are means for converting medium vibrations (sound waves) at two different points into electrical signals (acoustic signals). The microphones 1a and 1b will be called a microphone pair when they are collectively referred to.

The acoustic signal input unit 2 is a means for generating, in a time series manner, digital amplitude data of the two acoustic signals obtained by the microphones 1a and 1b by periodically A/D-converting these two acoustic signals at a predetermined sampling period Fr.

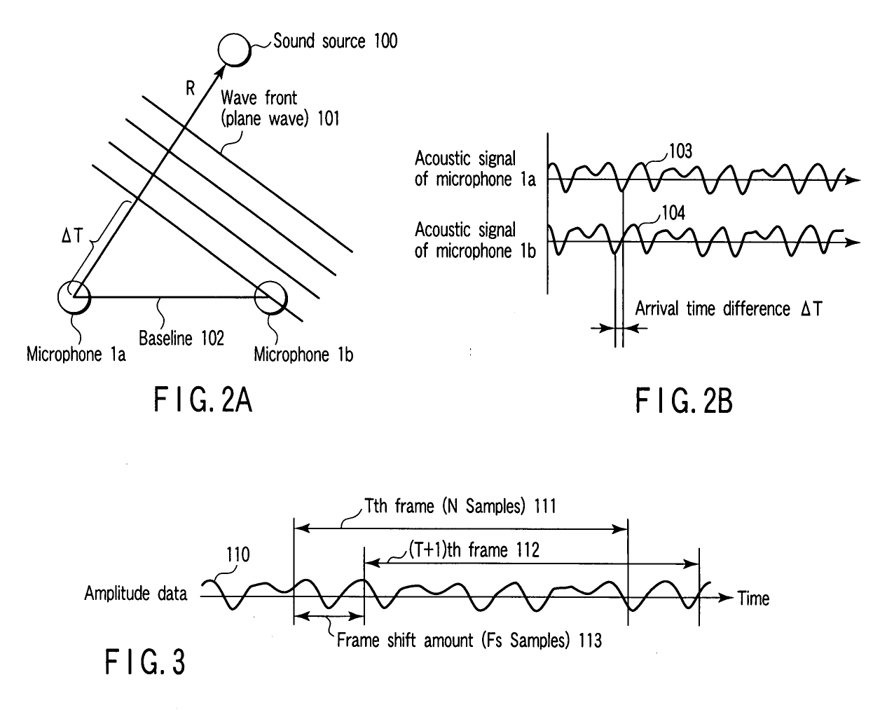

Assuming that a sound source is positioned at a distance much longer than the inter-microphone distance, as shown in FIG. 2A, a wave front 101 of a sound wave which is generated from a sound source 100 and reaches the microphone pair is substantially plane. When this plane wave is observed at two different points by using the microphones 1a and 1b, a predetermined arrival time difference ΔT is presumably observed between acoustic signals converted by the microphone pair, in accordance with a direction R of the sound source 100 with respect to a line segment 102 (to be referred to as a baseline hereinafter) connecting the microphones 1a and 1b. Note that when the sound source is far enough, the arrival time difference ΔT is 0 if the sound source 100 exists on a plane perpendicular to the baseline 102, and this direction is defined as a front direction of the microphone pair.

Reference 1 “Kaoru Suzuki et al., “Realization of “It Comes When It's Called” Function of Home Robot by Audio-Visual Interlocking”, The 4th Automatic Measurement Control Society System Integration Department Lecture Meeting (SI2003) Papers, 2F4-5, 2003” describes a method which derives the arrival time difference ΔT between two acoustic signals (103 and 104 in FIG. 2B) by detecting, by pattern collation, which part of one amplitude data is similar to which part of the other amplitude data. This method is effective when only one strong sound source exists. However, if strong background noise exists or a plurality of sound sources exist, no distinct similar portions appear on waveforms in which strong sounds in a plurality of directions mix, and pattern collation sometimes fails.

In this embodiment according to the present invention, therefore, input amplitude data is analyzed as it is decomposed into a phase difference for each frequency component. When a plurality of sound sources exist, a phase difference corresponding to the directions of sound sources is observed between two data for each frequency component of these sound sources. If phase differences of individual frequency components can be divided into groups of the individual directions without assuming strong limitations on sound sources, it is possible to estimate the number of sound sources, the directions of these sound sources, and the characteristics of frequency components of a sound wave mainly generated by each sound source. Although the theory itself is very simple, there are some problems to be solved when data is actually analyzed. These problems and functional blocks (the frequency decomposer 3, two-dimensional data formation unit 4, and figure detector 5) for performing this grouping will be explained below.

[Frequency Decomposer 3]

FFT (Fast Fourier Transform) is a general method of decomposing amplitude data into frequency components. A typical known algorithm is, e.g., the Cooley-Turkey DFT algorithm.

As shown in FIG. 3, the frequency decomposer 3 extracts N consecutive amplitude data as a frame (a Tth frame 111) from amplitude data 110 input from the acoustic signal input unit 2, performs FFT on the extracted frame, and repeats this processing (extracts a (T+1)th frame 112) by shifting the extraction position by a frame shift amount 113.

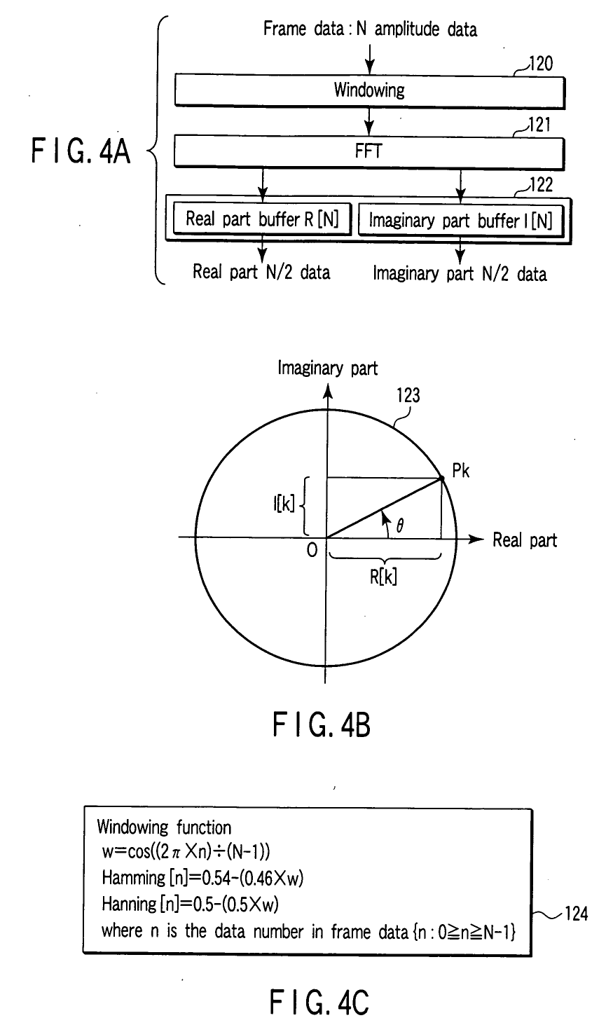

As shown in FIG. 4A, the amplitude data forming the frame undergoes windowing 120 and then FFT 121. As a consequence, FFT data of the input frame is generated in a real part buffer R[N] and imaginary part buffer I[N] (122). FIG. 4B shows an example of a windowing function (Hamming windowing or Hanning windowing) 124.

The FFT data thus generated is obtained by decomposing the amplitude data of this frame into N/2 frequency components. As shown in FIG. 4C, for a kth frequency component fk, the numerical values of a real part R[k] and imaginary part I[k] in the buffer 122 represent a point Pk on a complex coordinate system 123. The square of the distance from an origin O of Pk is power Po(fk) of this frequency component. A signed rotational angle θ{θ: −π>θ≧π[radian]} from the real part axis of Pk is a phase Ph(fk) of this frequency component.

When the sampling frequency is Fr [Hz] and the frame length is N [samples], k takes an integral value from 0 to (N/2)−1. In this case, k=0 represents 0 [Hz] (a direct current), k=(N/2)−1 represents Fr/2 [Hz] (the highest frequency component), and the frequency of each k is obtained by equally dividing a portion between these two values by frequency resolution Δf=(Fr/2)÷((N/2)−1) [Hz]. This frequency is represented by fk=k·Δf.

Note that as described previously, the frequency decomposer 3 continuously performs this processing at a predetermined interval (frame shift amount Fs), thereby generating, in a time series manner, a frequency-decomposed data set including the power value and phase value for each frequency of the input amplitude data.

(Two-Dimensional Data Formation Unit 4 & Figure Detector 5)

As shown in FIG. 5, the two-dimensional data formation unit 4 comprises a phase difference calculator 301 and coordinate value determinator 302. The figure detector 5 comprises a voting unit 303 and straight line detector 304.

[Phase Difference Calculator 301]

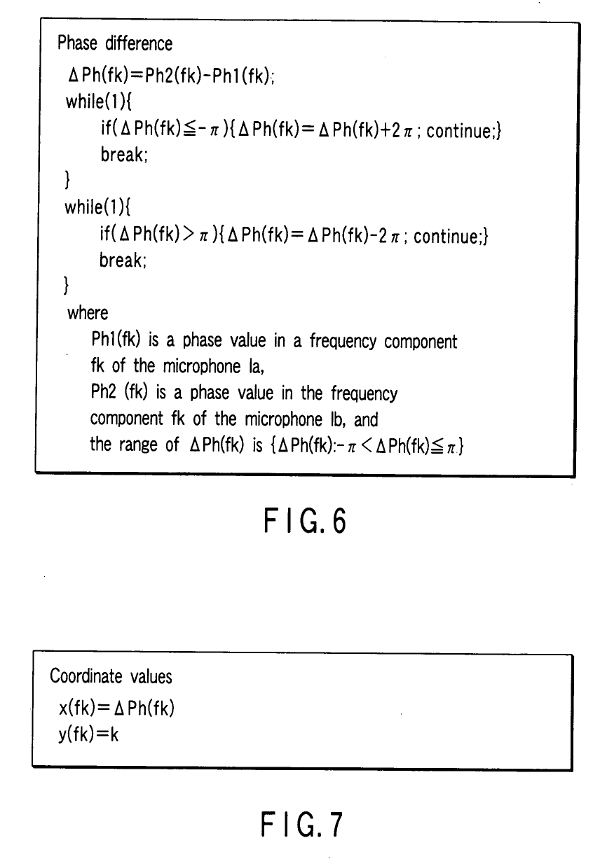

The phase difference calculator 301 is a means for comparing two frequency-decomposed data sets a and b obtained at the same timing by the frequency decomposer 3, and generating a-b phase difference data by calculating the difference between the phase values of the data sets a and b for each frequency component. For example, as shown in FIG. 6, a phase difference ΔPh(fk) for a certain frequency component fk is obtained by calculating the difference between a phase value Ph1(fk) at the microphone 1a and a phase value Ph2(fk) at the microphone 1b as a 2π remainder system such that the value of this difference satisfies {ΔPh(fk): −π<ΔPh(fk)≦π}.

[Coordinate Value Determinator 302]

The coordinate value determinator 302 is a means for determining, on the basis of the phase difference data obtained by the phase difference calculator 301, coordinate values for processing the phase difference data which is obtained by calculating the difference between the phase values of the two data sets for each frequency component, as a point on a predetermined X-Y coordinate system. An X-coordinate value x(fk) and Y-coordinate value y(fk) corresponding to a phase difference ΔPh(fk) for a certain frequency component fk are determined by equations shown in FIG. 7. The X-coordinate value is the phase difference ΔPh(fk), and the Y-coordinate value is a frequency component number k.

[Frequency Proportionality of Phase Difference to Same Time Difference]

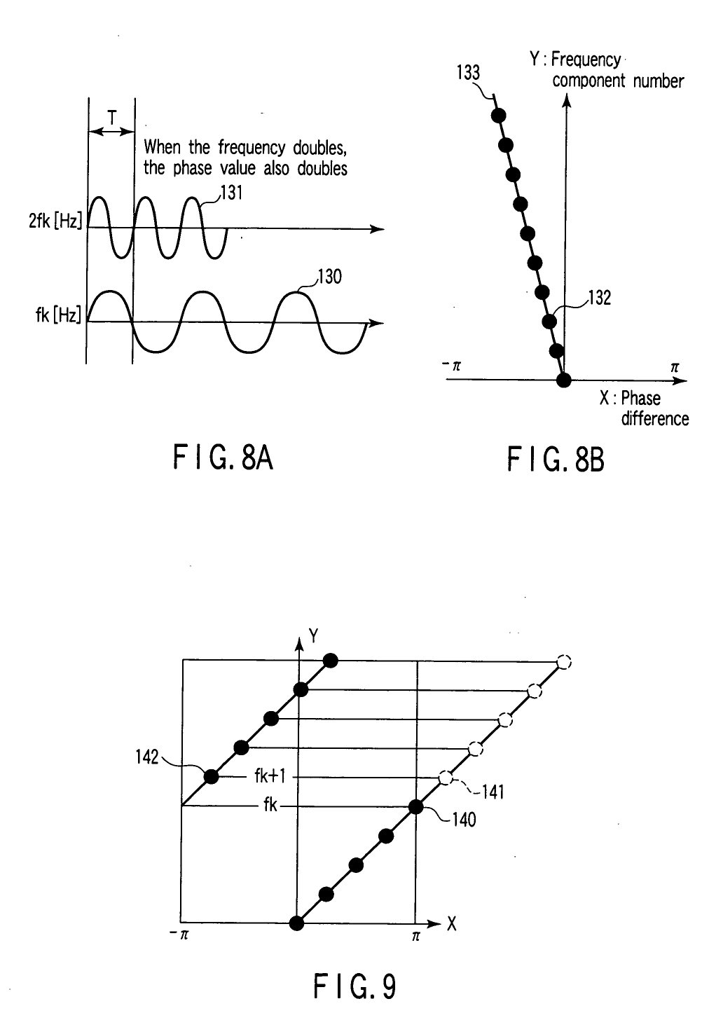

The phase differences of individual frequency components calculated by the phase difference calculator 301 as shown in FIG. 6 presumably represent the same arrival time difference if they come from the same sound source (the same direction). The phase value of a certain frequency and the phase difference between the microphones obtained by FFT are values calculated by setting the period of the frequency as 2π. If the frequency doubles, the phase difference also doubles even for the same time difference. FIGS. 8A and 8B illustrate this proportional relationship. As shown in FIG. 8A, for the same time T, a wave 130 having a frequency fk [Hz] contains a ½ period, i.e., a phase interval of π, but a wave 131 having a double frequency 2fk [Hz] contains one period, i.e., a phase interval of 2π. This similarly applies to the phase difference. That is, the phase difference increases in proportion to the frequency for the same time difference ΔT. FIG. 8B shows this proportional relationship between the phase difference and frequency. When the phase differences of individual frequency components generated from the same sound source and having ΔT in common are plotted on a two-dimensional coordinate system by the coordinate value calculations shown in FIG. 7, coordinate points 132 representing these phase differences of the individual frequency components are arranged on a straight line 133. As ΔT increases, i.e., as the difference between the distances from the microphones to the sound source increases, the inclination of this straight line increases.

[Circularity of Phase Difference]

Note that the phase difference between the microphones is proportional to the frequency in the entire region as shown in FIG. 8B only when a true phase difference falls within the range of ±π from the lowest frequency to the highest frequency as objects of analysis. This condition is that ΔT is less than the time of a ½ period of a highest frequency (half the sampling frequency) Fr/2 [Hz], i.e., less than 1/Fr [sec]. If ΔT is 1/Fr or more, a phase difference can be obtained only as a value having circularity as follows.

The phase value of each frequency component can be obtained only with a width of 2π (in this embodiment, a width of 2π between −π and π) as the value of the rotational angle θ shown in FIG. 4C. This means that even when the actual phase difference in this frequency component is one period or more between the microphones, it cannot be known from a phase value obtained as the result of frequency decomposition. In this embodiment, therefore, a phase difference is obtained between −π and π as shown in FIG. 6. However, a true phase difference resulting from ΔT may be a value calculated by adding 2π to or subtracting it from the obtained phase difference value, or further adding 4π or 6π to or subtracting it from the obtained value. This is schematically shown in FIG. 9. Referring to FIG. 9, when the phase difference ΔPh(fk) of the frequency fk is +π as indicated by a solid circle 140, a phase difference of an immediately higher frequency fk+1 exceeds +π as indicated by an open circle 141. However, a calculated phase difference ΔPh(fk+1) is slightly larger than −π obtained by subtracting 2π from the original phase difference, as indicated by a solid circle 142. Although not shown, even a three-fold frequency shows a similar value which is obtained by subtracting 4π from the actual phase difference. Thus, as the frequency rises, the phase difference circulates between −π and π as a 2π remainder system. If ΔT increases as in this example, a true phase difference indicated by an open circle circulates to the opposite side as indicated by a solid circle, when the frequency is a certain frequency fk+1 or higher.

[Phase Difference When Plural Sound Sources Exist]

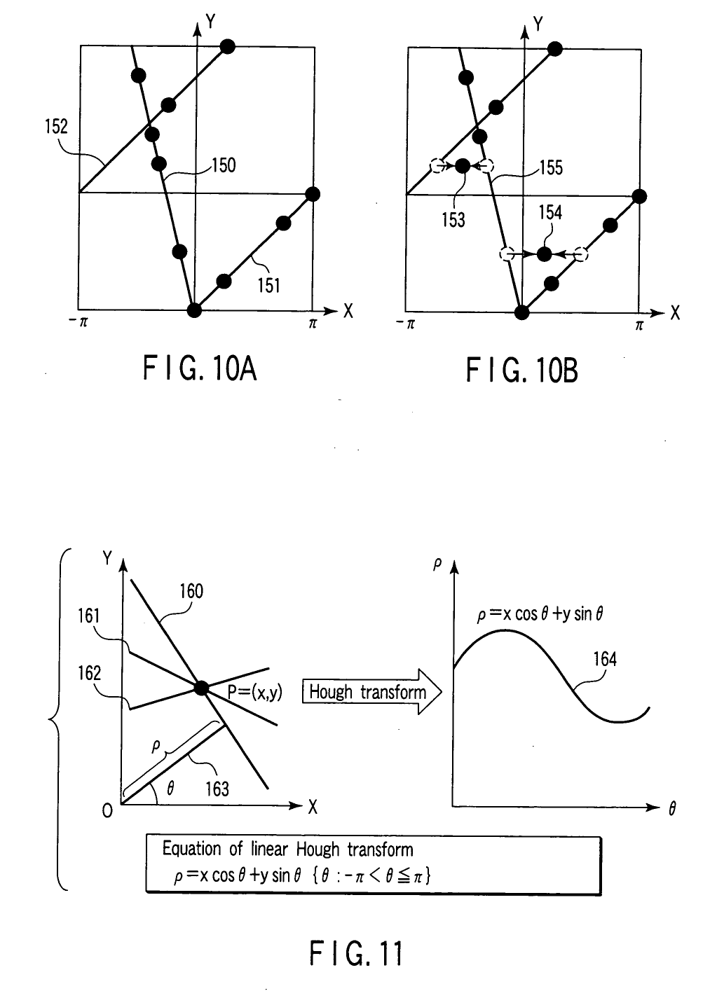

When sound waves are generated from a plurality of sound sources, on the other hand, plots of the frequency and phase difference are as schematically shown in FIGS. 10A and 10B. FIGS. 10A and 10B illustrate cases in which two sound sources exist in different directions with respect to the microphone pair. FIG. 10A shows a case in which the two source sounds do not contain the same frequency component. FIG. 10B shows a case in which some frequency components are contained in both the source sounds. Referring to FIG. 10A, a phase difference of each frequency component is present on one of straight lines having ΔT in common. That is, five points are arranged on a straight line 150 having a small inclination, and six points are arranged on a straight line 151 (including a circulated straight line 152) having a large inclination. Referring to FIG. 10B, in two frequency components 153 and 154 contained in both the source sounds, no phase differences can be correctly obtained because the waves mix, so no phase differences are arranged on any straight lines. In particular, only three points are arranged on a straight line 155 having a small inclination.

The problem of estimating the number and directions of sound sources resolves itself into finding straight lines in plots as shown in FIGS. 10A and 10B. Also, the problem of estimating the frequency components of each sound source resolves itself into selecting frequency components arranged near the detected straight lines. In this embodiment, the two-dimensional data output from the two-dimensional data formation unit 4 is a dot group determined as a function of a frequency and phase difference by using the two frequency-decomposed data sets obtained by the frequency decomposer 3, or an image obtained by arranging (plotting) dots of this dot group on a two-dimensional coordinate system. Note that this two-dimensional data is defined by two axes not including a time axis, so three-dimensional data as a time series of the two-dimensional data can be defined. The figure detector 5 detects, as a figure, the arrangement of straight lines from the arrangement of dots given as this two-dimensional data (or three-dimensional data as a time series of the two-dimensional data).

[Voting Unit 303]

The voting unit 303 is a means for applying linear Hough transform to each frequency component given (x, y) coordinates by the coordinate value determinator 302 as will be described later, and voting the obtained locus in a Hough voting space by a predetermined method. Although Hough transform is described in reference 2 “Akio Okazaki, “First Step in Image Processing”, Industrial Investigation Society, issued Oct. 20, 2000”, pp. 100-102, it will be explained again.

[Linear Hough Transform]

As schematically shown in FIG. 11, countless straight lines such as straight lines 160, 161, and 162 can pass through a point P(x, y) on a two-dimensional coordinate system. However, when the inclination of a perpendicular 163 drawn from an original O to each straight line is θ, and the length of the perpendicular 163 is ρ, θ and ρ are uniquely determined for one straight line. Pairs of θ and ρ which straight lines passing through a certain point (x, y) can take draw a locus 164 (ρ=xcosθ+ysinθ) unique to the value of (x, y) on a θ-ρ coordinate system. This transform from the (x, y) coordinate values into the locus of (θ, ρ) of straight lines which can pass through (x, y) is called linear Hough transform. Note that when a straight line inclines to the left, θ is a positive value, when a straight line is vertical, θ is 0, and when a straight line inclines to the right, θ is a negative value. Note also that the domain of θ does not fall outside {θ: −π<θ≦π}.

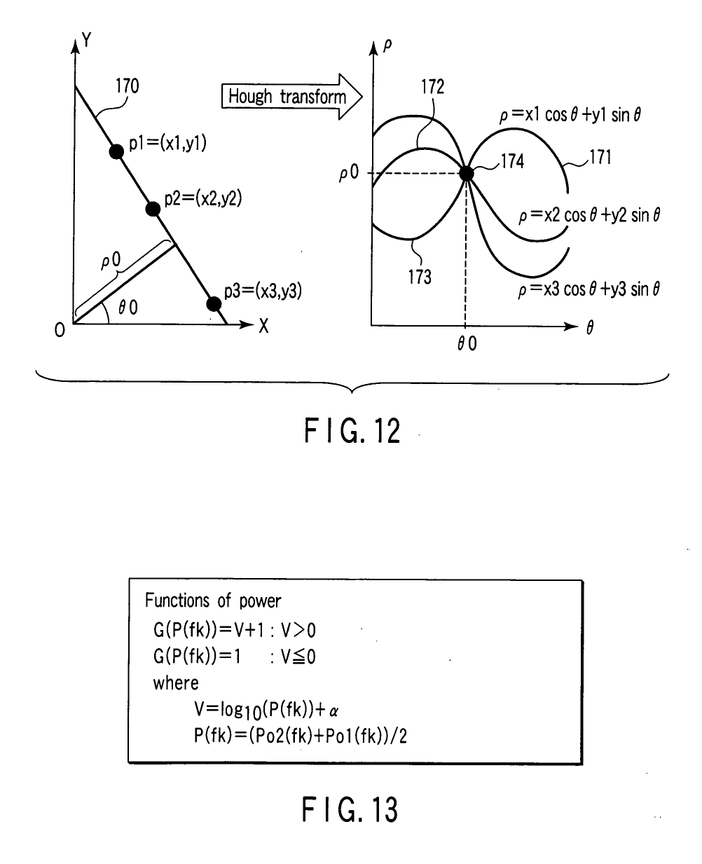

A Hough curve can be independently obtained for each point on the X-Y coordinate system. However, as shown in FIG. 12, a straight line 170 passing through three points p1, p2, and p3, for example, can be obtained as a straight line defined by the coordinates (θ0, ρ0) of a point 174 at which loci 171, 172, and 173 corresponding to the points p1, p2, and p3, respectively, intersect each other. As the number of points through which a straight line passes increases, the number of loci which pass through the position of θ and ρ representing the straight line increases. As described above, Hough transform is suited to detecting a straight line from dots.

[Hough Voting]

The engineering method called Hough voting is used to detect a straight line from dots. In this method, pairs of θ and ρ through which each locus passes are voted in a two-dimensional Hough voting space having θ and ρ as its coordinate axes, thereby indicating pairs of θ and ρ through which a large number of loci pass, i.e., the presence of a straight line, in a position having many votes in the Hough voting space. Generally, a two-dimensional array (Hough voting space) having the size of a necessary search range for θ and ρ is first prepared and initialized by 0. Then, the locus of each point is obtained by Hough transform, 1 is added to a value on the array through which this locus passes. This is called Hough voting. When voting for the loci of all points is complete, no straight line passing through one point exists in a position having no vote (through which no locus passes), a straight line passing through one point exists in a position having one vote (through which one locus passes), a straight line passing through two points exists in a position having two votes (through which two loci pass), and a straight line passing through n points exists in a position having n votes (through which n loci pass). If the resolution of the Hough voting space can be made infinite, only a point through which loci pass obtains votes corresponding to the number of loci passing through the point. However, since the actual Hough voting space is quantized at an appropriate resolution for θ and ρ, a high vote distribution is produced around a position at which a plurality of loci intersect each other. Therefore, it is necessary to accurately obtain a position at which loci intersect each other by searching for a position having a maximum value from the vote distribution in the Hough voting space.

The voting unit 303 performs Hough voting for frequency components meeting both of the following voting conditions. Under the conditions, voting is performed only for frequency components in a predetermined frequency band and having power equal to or higher than a predetermined threshold value.

That is, voting condition 1 is that a frequency falls within a predetermined range (low-frequency cutoff and high-frequency cutoff). Voting condition 2 is that the power P(fk) of the frequency component fk is equal to or higher than a predetermined threshold value.

Voting condition 1 is used to cut off a low frequency on which dark noise is generally carried, and to cut off a high-frequency at which the FFT accuracy lowers. The ranges of low-frequency cutoff and high-frequency cutoff can be adjusted in accordance with the operation. When the widest frequency band is to be used, it is preferable to cut off only the DC component as a low frequency and cut off only the maximum frequency as a high frequency.

The reliability of the results of FFT is probably low for a very weak frequency component such as dark noise. Voting condition 2 is used to prevent this low-reliability frequency component from participating in voting by threshold value processing using power. Assuming that the microphone 1a has a power value Po1(fk) and the microphone 1b has a power value Po2(fk), the following three conditions can be used to determine power P(fk) to be evaluated. Note that a condition to be used can be selected in accordance with the operation.

(Average value): The average value of Po1(fk) and Po2(fk) is used. This condition requires both the two powers to be properly strong.

(Minimum value): A smaller one of Po1(fk) and Po2(fk) is used. This condition requires both the two powers to be at least equal to a threshold value.

(Maximum value): A larger one of Po1(fk) and Po2(fk) is used. Under this condition, even when one is smaller than a threshold value, voting is performed if the other is strong enough.

Also, the voting unit 303 can perform the following two addition methods in voting.

That is, in addition method 1, a predetermined fixed value (e.g., 1) is added to a position through which a locus passes. In addition method 2, the function value of power P(fk) of the frequency component fk is added to a position through which a locus passes.

Addition method 1 is generally often used in Hough transform straight line detection problems. Since votes are ordered in proportion to the number of points of passing, addition method 1 is suited to preferentially detecting a straight line (i.e., a sound source) containing many frequency components. In this method, frequency components contained in a straight line need not have any harmonic structure (in which contained frequencies are equally spaced). Therefore, various types of sound sources can be detected as well as a human voice.

In addition method 2, even when the number of points of passing is small, a maximum value in a higher position can be obtained if high-power frequency components are contained. Addition method 2 is suited to detecting a straight line (i.e., a sound source) containing a small number of frequency components but having a high-power, influential component. In addition method 2, the function value of power P(fk) is calculated as G(P(fk)). FIG. 13 shows equations for calculating G(P(fk)) when P(fk) is the average value of Po1(fk) and Po2(fk). In addition, as in voting condition 2, P(fk) may also be calculated as the minimum value or maximum value of Po1(fk) and Po2(fk). That is, addition method 2 can be set in accordance with the operation independently of voting condition 2. The value of an intermediate parameter V is calculated as a value obtained by adding a predetermined offset α to a logarithmic value log₁₀(P(fk)) of P(fk). If V is positive, the value of V+1 is used as the value of the function G(P(fk)), and, if V is zero or less, 1 is used. By thus voting at least 1, addition method 2 can also be given the properties of decision by majority of addition method 1, i.e., not only a straight line (sound source) containing a high-power frequency component floats to a higher position, but also a straight line (sound source) containing many frequency components floats to a higher position. The voting unit 303 can perform either addition method 1 or addition method 2 in accordance with the setting. However, when the latter method is used, sound sources having few frequency components can also be detected at the same time. Accordingly, more various types of sound sources can be detected.

[Collective Voting of Plural FFT Results]

Furthermore, although the voting unit 303 can vote whenever FFT is performed, it generally performs collective voting for m (m≧1) consecutive, time series FFT results. The frequency components of a sound source vary for long time periods. However, by thus performing collective voting, Hough voting results having higher reliability can be obtained by using a large number of data obtained from FFT results at a plurality of timings during an appropriately short period in which frequency components are stable. Note that m can be set as a parameter in accordance with the operation.

[Straight Line Detector 304]

The straight line detector 304 is a means for detecting a powerful straight line by analyzing the vote distribution on the Hough voting space generated by the voting unit 303. Note that in this case, a straight line can be detected with higher accuracy by taking account of the unique situations of this problem, e.g., the circularity of the phase difference explained with reference to FIG. 9.

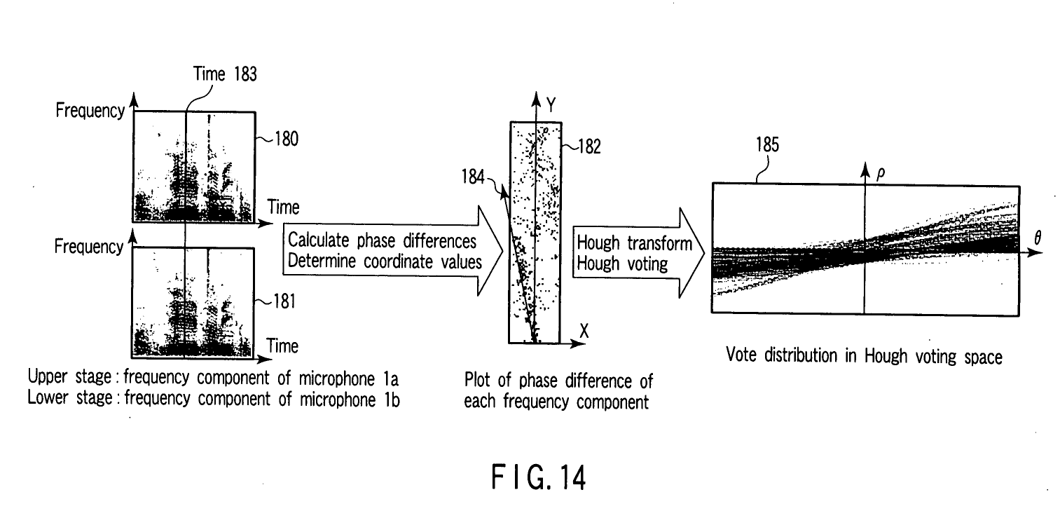

FIG. 14 shows the power spectrum of frequency components when an actual voice uttered by a person at an angle of about 20° to the left from the front of the microphone pair is processed in an indoor noise environment, a phase difference plot of each frequency component obtained from five (m (described above)=5) consecutive FFT results, and Hough voting results (a vote distribution) obtained from the same five FFT results. The processing up to this point is executed by a series of functional blocks from the acoustic signal input unit 2 to the voting unit 303.

Amplitude data acquired by the microphone pair is converted into data of a power value and phase value for each frequency component by the frequency decomposer 3. Referring to FIGS. 14, 180 and 181 are graphs in each of which the logarithm of the power value of each frequency component is indicated by brightness (the darker the indication, the larger the value) by plotting the time on the abscissa. One vertical line corresponds to one FFT result, and these lines are formed into a graph along the passage of time (to the right). The upper stage 180 shows the results of processing of signals from the microphone 1a, and the lower stage 181 shows the results of processing of signals from the microphone 1b. Many frequency components are detected in both the upper and lower stages. On the basis of these frequency decomposition results, the phase difference calculator 301 calculates a phase difference for each frequency component, and the coordinate value determinator 302 calculates the (x, y) coordinate values of the phase difference. Referring to FIG. 14, 182 is a graph in which phase differences obtained by five consecutive FFT processes from certain time 183 are plotted. In this graph, a dot distribution is shown along a straight line 184 which inclines to the left from the origin. However, this distribution is not exactly present on the straight line 184, and a large number of dots separated from the straight line 184 are present. The voting unit 303 votes the thus distributed dots in the Hough voting space to form a vote distribution 185. Note that the vote distribution 185 is generated by using addition method 2.

[Limitation ρ=0]

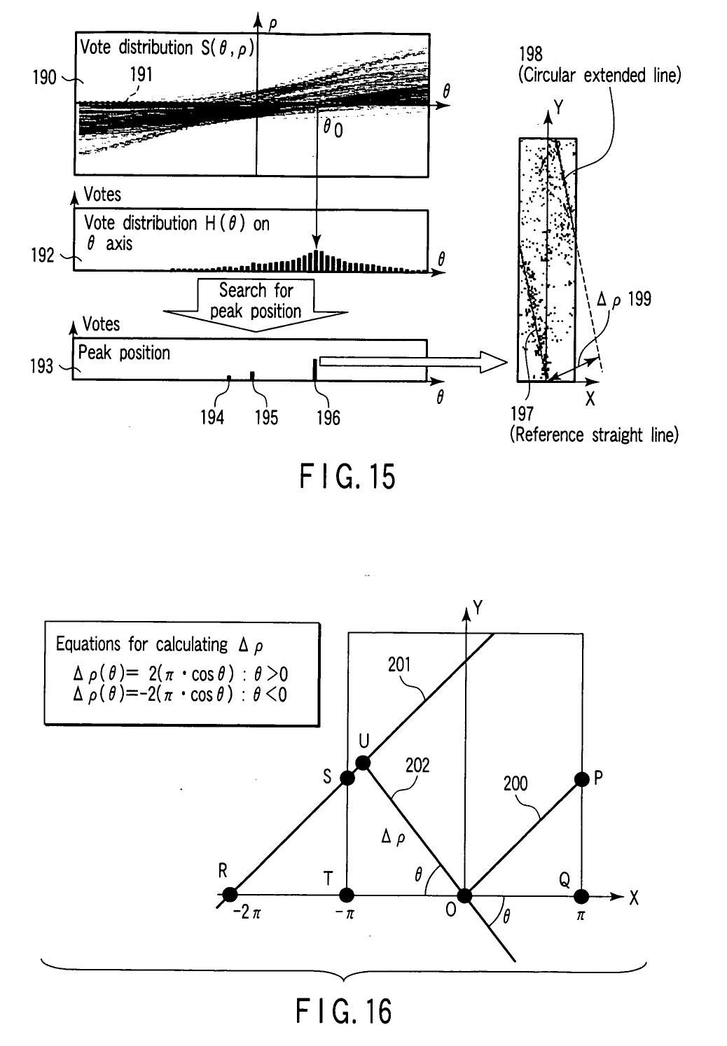

When signals from the microphones 1a and 1b are A/D-converted in phase with each other by the acoustic signal input unit 2, a straight line to be detected always satisfies ρ=0, i.e., always passes through the origin of the X-Y coordinate system. Accordingly, the problem of sound source estimation resolves itself into a problem of searching for a maximum value from a vote distribution S(θ, 0) on the θ axis in which ρ=0 in the Hough voting space. FIG. 15 shows the results of search for a maximum value on the θ axis from the data shown in FIG. 14.

A vote distribution 190 shown in FIG. 15 is the same as the vote distribution 185 shown in FIG. 14. A bar graph 192 is obtained by extracting as H(θ) a vote distribution S(θ, 0) on a θ axis 191. The vote distribution H(θ) has some peak portions (projecting portions). The straight line detector 304 (1) performs search as long as the same points as itself continue on the left and right sides in a certain position of the vote distribution H(θ), and leaves a portion where only fewer votes than itself appear last. As a consequence, a peak portion in the vote distribution H(θ) is extracted. Since this peak portion includes a portion having a flat peak, a maximum value continues in a portion like this. Therefore, the straight line detector 304 (2) leaves only a central position of the peak portion as a peak position 193 by a line thinning process. Finally, the straight line detector 304 (3) detects, as a straight line, only a peak position where the number of votes is equal to or larger than a predetermined threshold value. In this way, θ of a straight line having enough votes can be accurately found. In the example shown in FIG. 15, of peak positions 194, 195, and 196 detected in (2) described above, the peak position 194 is a central position (if an even number of peak positions continue, the right-side position is given priority) left behind by the line thinning process from the flat peak portion. Also, only the peak position 196 is a straight line detected by obtaining the number of votes larger than the threshold value. A straight line (reference straight line) 197 is defined by θ and ρ(=0) given by the peak position 196. Note that as the algorithm of the line thinning process, it is possible to use a one-dimensional version of “Tamura's Method” described in reference 2 used in the explanation of Hough transform, pp. 89 to 92. When thus detecting one or a plurality of peak positions (central positions having the number of votes equal to or larger than a predetermined threshold value), the straight line detector 304 arranges these positions in descending order of vote, and outputs the values of θ and ρ of each peak position.

[Definition of Straight Line Group Taking Account of Phase Difference Circularity]

The straight line 197 shown in FIG. 15 passes through the X-Y coordinate origin defined by the peak position 196 which is (θ0, 0). In practice, however, owing to the circularity of the phase difference, a straight line 198 also shows the same arrival time difference as that of the straight line 197. The straight line 198 is obtained when the straight line 197 shown in FIG. 15 moves parallel by Δρ 199 and circulates from the opposite side on the X axis. A straight line such as the straight line 198 obtained when the straight line 197 is extended and a portion extended from the X-value region circularly appears from the opposite side will be called a “circular extended line” hereinafter, and the straight line 197 as a reference will be called a “reference straight line” hereinafter. If the reference straight line 197 further inclines, the number of circular extended lines further increases. If a coefficient a is an integer of 0 or more, all straight lines having the same arrival time difference form a straight line group (θ0, aΔρ) obtained when the reference straight line 197 defined by (θ0, 0) moves parallel by Δρ at once. In addition, if ρ as the starting point is generalized as ρ=ρ0 by removing limitation ρ=0, this straight line group can be described as (θ0, aΔρ+ρ0). In this case, Δρ is a signed value defined by equations shown in FIG. 16 as a function Δρ(θ) of the inclination θ of a straight line.

Referring to FIG. 16, a reference straight line 200 can be defined by (θ, 0). Since the reference straight line inclines to the right, θ has a negative value in accordance with the definition. In FIG. 16, however, θ is handled as an absolute value in FIG. 16. A straight line 201 shown in FIG. 16 is a circular extended line of the reference straight line 200, and intersects the X axis at a point R. Also, the spacing between the reference straight line 200 and circular extended line 201 is Δρ as indicated by an auxiliary line 202. The auxiliary line 202 perpendicularly intersects the reference straight line 200 at a point O, and perpendicularly intersects the circular extended line 201 at a point U. Since the reference straight line inclines to the right, Δρ has a negative value in accordance with the definition. However, Δρ is handled as an absolute value in FIG. 16. ΔOQP in FIG. 16 is a right-angled triangle in which the length of a side OQ is π. A triangle which is congruent with ΔOQP is ΔRTS. Therefore, the length of a side RT is also π, and the length of an oblique side OR of ΔOUR is 2π. Since Δρ is the length of a side OU, Δρ=2πcosθ. The equations shown in FIG. 16 are derived by taking the signs of θ and Δρ into consideration.

[Peak Position Detection Taking Account of Phase Difference Circulation]

As described above, a straight line representing a sound source should be handled as not one straight line but a straight line group including a reference straight line and circular extended line, owing to the circularity of the phase difference. This must also be taken into consideration when a peak position is to be detected from a vote distribution. When a sound source is to be detected only in the vicinity of the front of the microphone pair where no phase difference circulation occurs or the scale of phase difference circulation is small even if it occurs, the above-mentioned method which searches for a peak position only by the number of votes on ρ=0 (or ρ=ρ0) (i.e., the number of votes of a reference straight line) is not only satisfactory in performance, but also has effects of shortening the search time and increasing the search accuracy. However, when a sound source in a wider range is to be detected, it is necessary to search for a peak position by totalizing the numbers of votes in several portions separated from each other by Δρ with respect to a certain θ. This difference will be explained below.

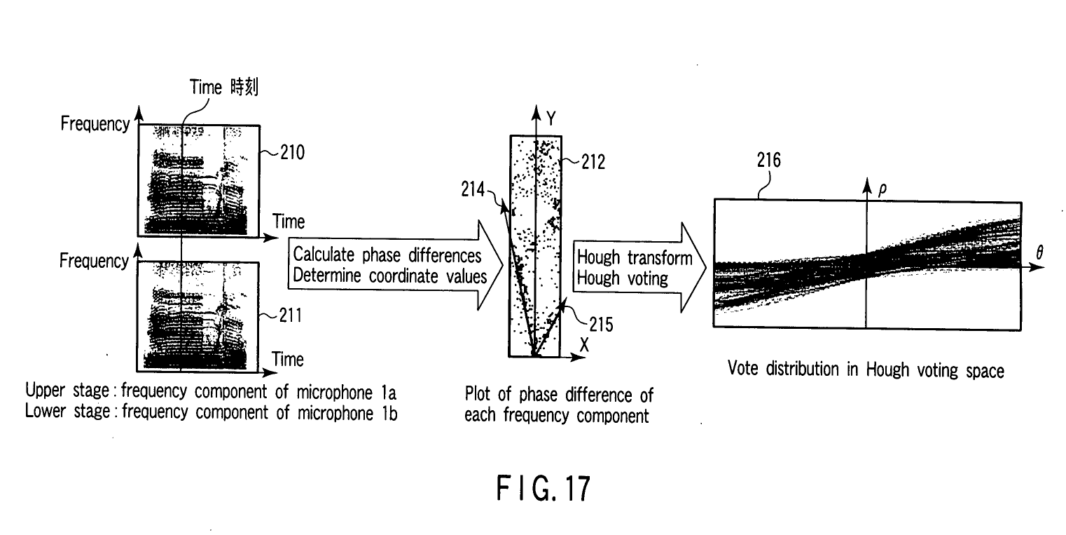

FIG. 17 shows the power spectra of frequency components obtained when actual voices simultaneously uttered by two persons at an angle of about 20° to the left and at an angle of about 45° to the right from the front of the microphone pair in an indoor noise environment are processed, a phase difference plot of each frequency component obtained from five (m=5) FFT results, and Hough voting results (a vote distribution) obtained from the same five FFT results.

Amplitude data acquired by the microphone pair is converted into data of a power value and phase value for each frequency component by the frequency decomposer 3. Referring to FIGS. 17, 210 and 211 are graphs in each of which the logarithm of the power value of each frequency component is indicated by brightness (the darker the indication, the larger the value) by plotting the frequency on the ordinate and the time on the abscissa. One vertical line corresponds to one FFT result, and these lines are formed into a graph along the passage of time (to the right). The upper stage 210 shows the results of processing of signals from the microphone 1a, and the lower stage 211 shows the results of processing of signals from the microphone 1b. Many frequency components are detected in both the upper and lower stages. On the basis of these frequency decomposition results, the phase difference calculator 301 calculates a phase difference of each frequency component, and the coordinate value determinator 302 calculates the (x, y) coordinate values of the phase difference. In a plot 212, phase differences obtained by five consecutive FFT processes from certain time 213 are plotted. The plot 212 shows a dot distribution along a straight line 214 which inclines to the left from the origin, and a dot distribution along a reference straight line 215 which inclines to the right. The voting unit 303 votes the thus distributed dots in the Hough voting space to form a vote distribution 216. Note that the vote distribution 216 is generated by using addition method 2.

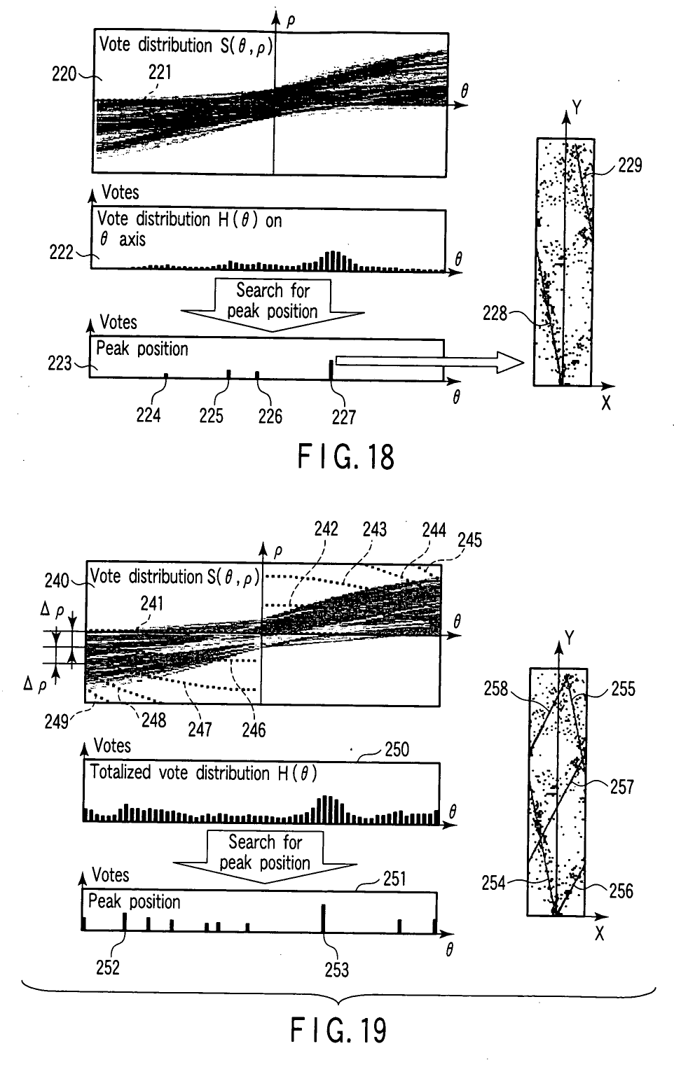

FIG. 18 is a view showing the results of search for peak positions only by the number of votes on the θ axis. A vote distribution 220 in FIG. 18 is the same as the vote distribution 216 shown in FIG. 17. A bar graph 222 is obtained by extracting as H(O) a vote distribution S(θ, 0) on a θ axis 221. The vote distribution H(θ) has some peak portions (projecting portions). Generally, the larger the absolute value of θ, the smaller the number of votes. From the vote distribution H(θ), four peak positions 224, 225, 226, and 227 are detected as indicated by a peak position graph 223. Of these peak positions, only the peak position 227 obtains the number of votes larger than a threshold value. In this manner, one straight line group (a reference straight line 228 and circular extended line 229) is detected. This straight line group is obtained by detecting the voice at an angle of about 20° to the left from the front of the microphone pair. However, the voice at an angle of about 45° to the right from the front of the microphone pair is not detected. As the angle of a reference straight line passing through the origin increases, the number of frequency bands through which this reference straight line can pass before exceeding the X-value region decreases. Therefore, the width of a frequency band through which the reference straight line passes changes in accordance with θ (i.e., unfairness exists). Limitation ρ=0 puts the numbers of votes of only the reference straight lines into competition with each other under this unfair condition. Accordingly, the larger the angle of a straight line, the larger the disadvantage in competition of votes. This is the reason why the voice at an angle of about 45° to the right cannot be detected.

FIG. 19 shows the results of search for peak positions by totalizing the numbers of votes in several portions separated from each other by Δρ. In 240 of FIG. 19, the positions of ρ when a straight line passing through the origin is moved parallel by Δρ at one time are indicated by dotted lines 242 to 249 on the vote distribution 216 shown in FIG. 17. A θ axis 241 and the dotted lines 242 to 245 and the θ axis 241 and dotted lines 246 to 249 are equally spaced by natural number multiples of Δρ(θ). Note that no dotted line exists for θ=0 by which the straight line does not exceed the X-value region and reliably extends to the ceiling of the plot.

A vote H(θ0) of certain θ0 is calculated as the total value of votes on the θ axis 241 and on the dotted lines 242 to 249 when vertically viewed in a position where θ=θ0, i.e., as H(θ0)=Σ{S(θ0, aΔρ(θ0))}. This manipulation is equivalent to totalizing votes of a reference straight line by which θ=θ0 and votes of its circular extended line. 250 in FIG. 19 shows the vote distribution H(θ) as a bar graph. In this distribution, unlike in 222 of FIG. 18, even when the absolute value of θ increases, the number of votes does not decrease. This is so because the same frequency band can be used for all θ values by adding a circular extended line to vote calculations. In the vote distribution 250, ten peak positions shown in 251 of FIG. 19 are detected. Of these peak positions, peak positions 252 and 253 each obtain the number of votes larger than a threshold value, and two straight line groups are detected. That is, one straight line group (a reference straight line 254 and circular extended line 255 corresponding to the peak position 253) is detected by detecting a voice at an angle of about 20° to the left from the front of the microphone pair, and the other straight line group (a reference straight line 256 and circular extended lines 257 and 258 corresponding to the peak position 252) is detected by detecting a voice at an angle of about 45° to the right from the front of the microphone pair. By thus searching for peak positions by totalizing votes in portions separated from each other by Δρ, it is possible to stably detect straight lines from a straight line having a small angle to a straight line having a large angle.

[Peak Position Detection Taking Account of Out-of-Phase: Generalization]

If signals from the microphones 1a and 1b are not A/D-converted in phase with each other by the acoustic signal input unit 2, a straight line to be detected is ρ=0, i.e., does not pass through the X-Y coordinate origin. In this case, peak positions must be searched for by removing limitation ρ=0.

When a reference line from which limitation ρ=0 is removed is described as (θ0, ρ0) by generalization, its straight line group (a reference straight line and circular extended line) can be described as (θ0, aΔρ(θ0)+ρ0). Δρ(θ0) is a parallel move amount of the circular extended line determined by θ0. When a sound source comes in a certain direction, only one most powerful straight line group exists for θ0 corresponding to the sound source. This straight line group is given by (θ0, aΔρ(θ0)+ρ0max) by using a value ρ0max of ρ0 by which a vote Σ{S(θ0, aΔρ(θ0)+ρ0)} of the straight line group when ρ0 is variously changed is a maximum. Therefore, it is possible, by using a vote H(θ) of each θ as the maximum vote Σ{S(θ0, aΔρ(θ0)+ρ0)} of that θ, to perform straight line detection using the same peak position detection algorithm which is used when limitation ρ=0 is imposed.

Note that the number of straight line groups thus detected is the number of sound sources.

[Sound Source Information Generator 6]

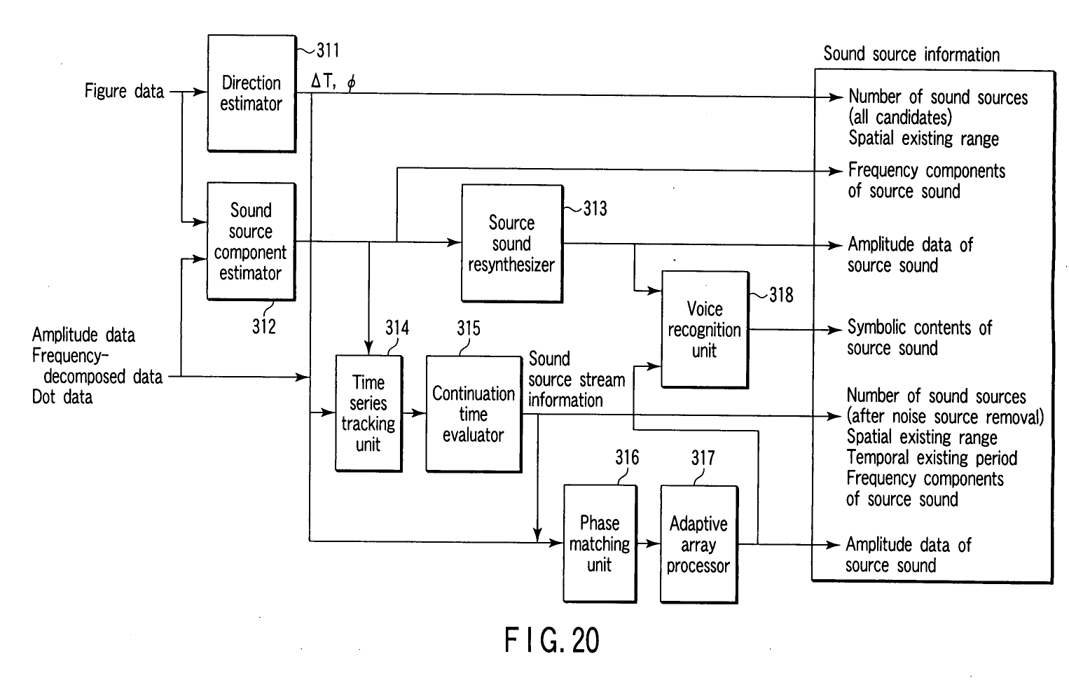

As shown in FIG. 20, the sound source information generator 6 comprises a direction estimator 311, sound source component estimator 312, source sound resynthesizer 313, time series tracking unit 314, continuation time evaluator 315, phase matching unit 316, adaptive array processor 317, and voice recognition unit 318.

[Direction Estimator 311]

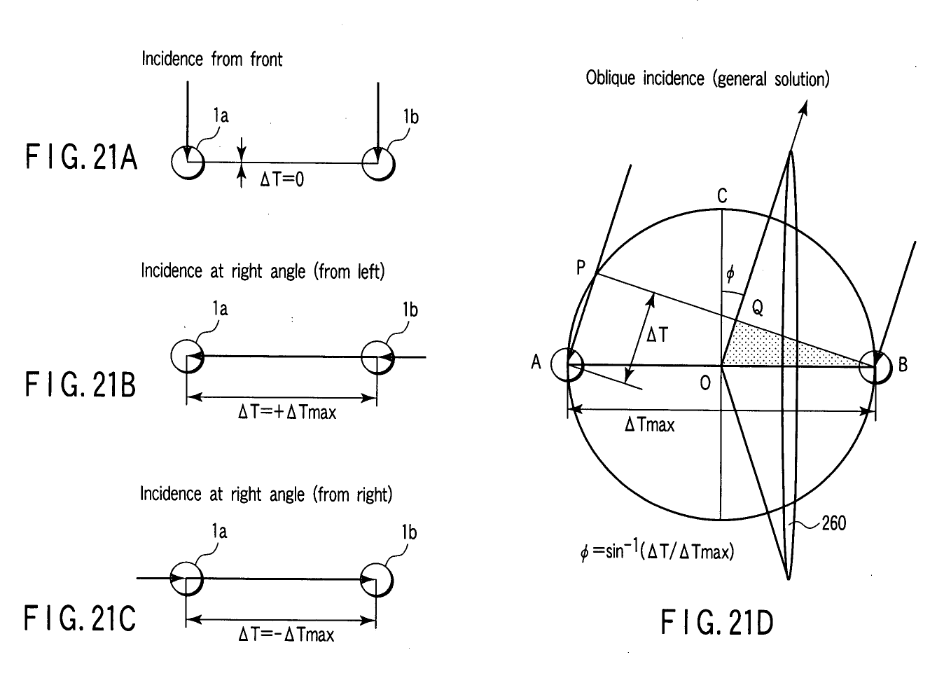

The direction estimator 311 is a means for receiving the straight line detection results obtained by the straight line detector 304 described above, i.e., receiving the θ value of each straight line group, and calculating the existing range of a sound source corresponding to each straight line group. The number of detected straight line groups is the number of sound sources (all candidates). If the distance to a sound source is much longer than the baseline of the microphone pair, the sound source existing range is a circular cone having a certain angle to the baseline of the microphone pair. This will be explained below with reference to FIG. 21.

An arrival time difference ΔT between the microphones 1a and 1b can change within the range of ±ΔTmax. When a sound is incident from the front as shown in FIG. 21A, ΔT is 0, and an azimuth φ of the sound source is 0° from the front. When a sound is incident at a right angle from the right side, i.e., incident in the direction of the microphone 1b as shown in FIG. 21B, ΔT is equal to +ΔTmax, and the azimuth φ of the sound source is +90° when it is assumed that a clockwise rotation is a positive direction from the front. Likewise, when a sound is incident at a right angle from the left side, i.e., incident in the direction of the microphone 1a as shown in FIG. 21C, ΔT is equal to −ΔTmax, and the azimuth φ is −90°. As described above, ΔT is so defined that it is positive when a sound is incident from the right side and negative when a sound is incident from the left side.

On the basis of the above definition, a general condition as shown in FIG. 21D will be described below. Assuming that the position of the microphone 1a is A, the position of the microphone 1b is B, and a sound is incident in the direction of a line segment PA, ΔPAB is a right-angled triangle whose apex P is a right angle. In this case, assuming that the center between the microphones is O, a line segment OC is the front direction of the microphone pair, and an OC direction is an azimuth of 0°, an angle whose counterclockwise rotation is positive is defined as the azimuth φ. Since ΔQOB is similar to ΔPAB, the absolute value of the azimuth φ is equal to ∠OBQ, i.e., ∠ABP, and the sign matches the sign of ΔT. Also, ∠ABP can be calculated as sin⁻¹ of the ratio of PA to AB. When the length of the line segment PA is represented by corresponding ΔT, the length of the line segment AB is equivalent to ΔTmax. Accordingly, the azimuth and its sign can be calculated by φ=sin⁻¹(ΔT/ΔTmax). The sound source existing range is estimated as a circular cone 260 which has the point O as its apex and the baseline AB as its axis, and opens at (90−φ)°. The sound source is somewhere on the circular cone 260.

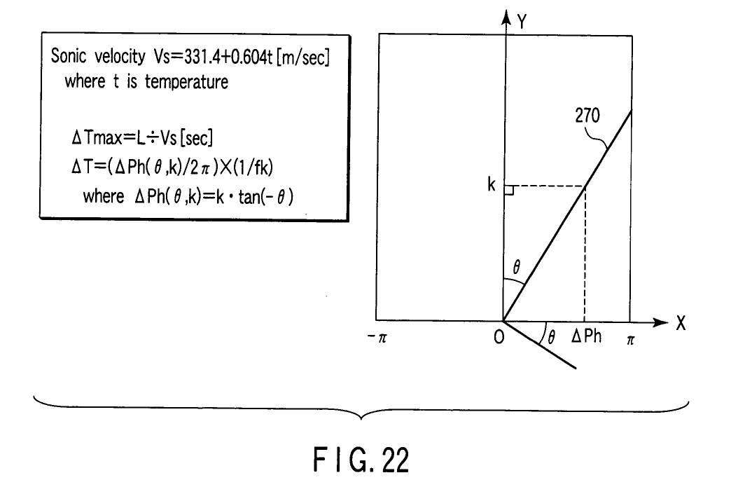

As shown in FIG. 22, ΔTmax is calculated by dividing an inter-microphone distance L [m] by a sonic velocity Vs [m/sec]. The sonic velocity Vs can be approximated as a function of a temperature t [° C.]. Assume that a straight line 270 is detected to have a Hough inclination θ by the straight line detector 304. Since the straight line 270 inclines to the right, θ has a negative value. If y=k (the frequency fk), a phase difference ΔPh indicated by the straight line 270 can be calculated by k·tan(−θ) as a function of k and θ. In this case, ΔT [sec] is a time obtained by multiplying the period (1/fk) [sec] of the frequency fk by the ratio of the phase difference ΔPh(θ, k) to 2π. Since θ is a signed amount, ΔT is also a signed amount. That is, when a sound is incident from the right side in FIG. 21D (when the phase difference ΔPh has a positive value), θ has a negative value. Also, when a sound is incident from the left side in FIG. 21D (when the phase difference ΔPh has a negative value), θ has a positive value. Therefore, the sign of θ is inverted. Note that actual calculations need only be performed by using k=1 (a frequency immediately higher than DC component k=0).

[Sound Source Component Estimator 312]

The sound source component estimator 312 is a means for evaluating the distance between the (x, y) coordinate values of each frequency component given by the coordinate value determinator 302 and the straight line detected by the straight line detector 304, thereby detecting points (i.e., frequency components) positioned near the straight line as frequency components of the straight line (i.e., a sound source), and estimating frequency components of each sound source on the basis of the detection results.

[Detection by Distance Threshold Method]

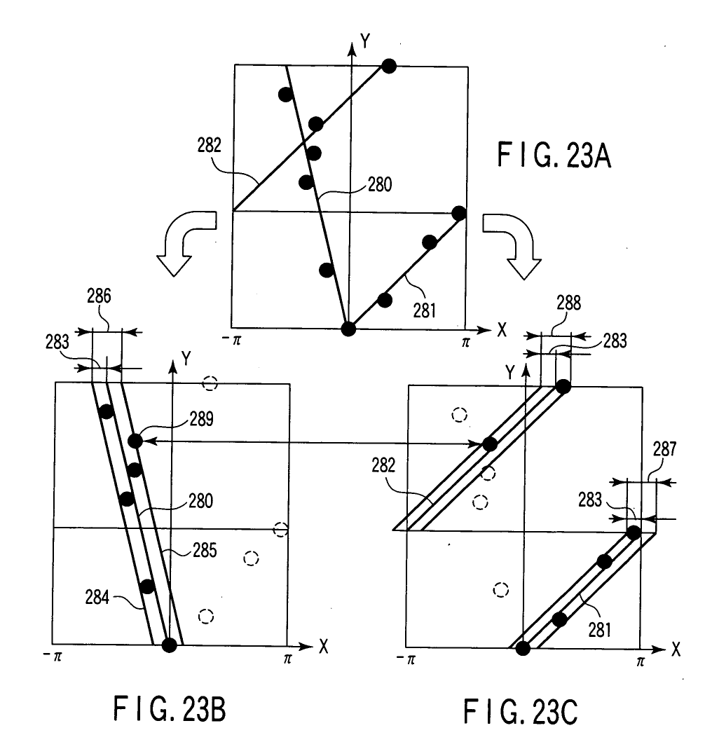

FIGS. 23A to 23C schematically show the principle of sound source component estimation when a plurality of sound sources exist. FIG. 23A is the same plot of the frequency and phase difference as that shown in FIG. 9, and illustrates a case in which two sound sources exist in different directions with respect to the microphone pair. In FIG. 23A, reference numeral 280 denotes one straight line group; and 281 and 282, other straight line groups. Solid circles in FIG. 23A represent the phase difference positions of individual frequency components.

As shown in FIG. 23B, frequency components of a source sound corresponding to the straight line group 280 are detected as frequency components (solid circles) positioned in a region 286 sandwiched between straight lines 284 and 285 separated from the straight line 280 to the left and right, respectively, by a horizontal distance 283. When a certain frequency component is detected as a component of a certain straight line, an expression that this frequency component reverts to (or belongs to) the straight line will be used in the following explanation.

Similarly, as shown in FIG. 23C, frequency components of a source sound corresponding to the straight line group 281 are detected as frequency components (solid circles) positioned in a region 287 sandwiched between straight lines separated from the straight line 281 to the left and right by the horizontal distance 283, and frequency components of a source sound corresponding to the straight line group 282 are detected as frequency components (solid circles) positioned in a region 288 sandwiched between straight lines separated from the straight line 282 to the left and right by the horizontal distance 283.

Note that two points, i.e., a frequency component 289 and the origin (DC component) are contained in both the regions 286 and 288, so they are doubly detected as components of these two sound sources (multiple reversion). This method which selects frequency components present within the range of a threshold value for each straight line group (sound source) by performing threshold processing for the horizontal distances between frequency components and straight lines, and uses the obtained power and phase directly as components of the source sound will be called a “distance threshold method” hereinafter.

[Detection by Nearest Neighbor Method]

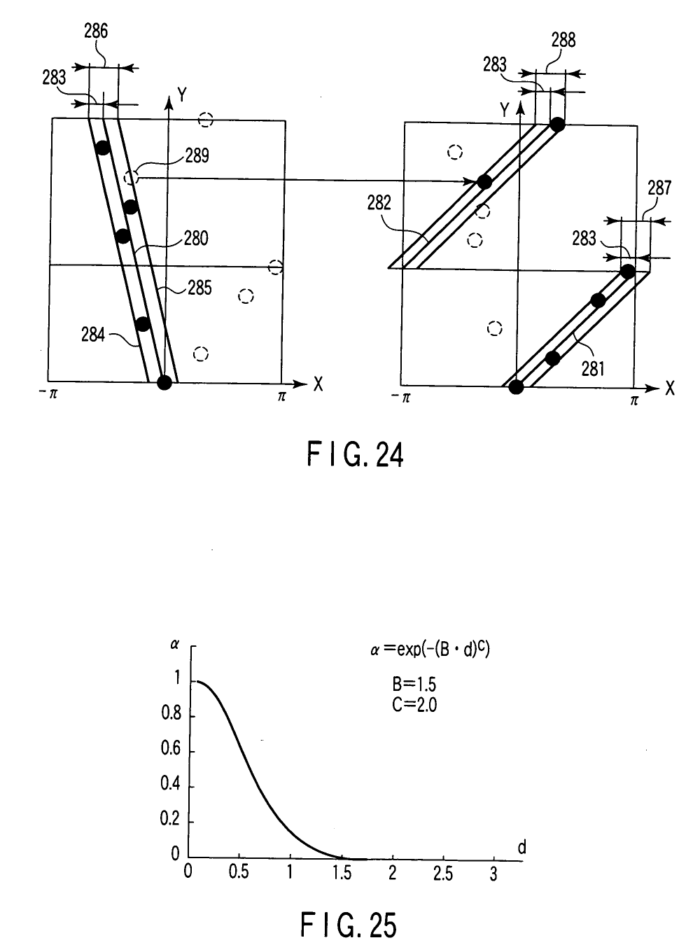

FIG. 24 is a view showing the results of processing by which the frequency component 289 of multiple reversion shown in FIG. 23B is allowed to revert only to the closest straight line group. When the horizontal distances of the frequency component 289 from the straight lines 280 and 282 are compared, it is found that the frequency component 289 is closest to the straight line 282. In this case, the frequency component 289 is contained in the region 288 near the straight line 282. Accordingly, as shown in FIG. 24B, the frequency component 289 is detected as a component which belongs to the straight line group (281 and 282). This method which selects a straight line (sound source) having the shortest horizontal distance for each frequency component, and, if this horizontal distance is present within the range of a predetermined threshold value, uses the power and phase of the frequency component directly as components of the source sound will be called a “nearest neighbor method” hereinafter. Note that the DC component (origin) is allowed to revert to both the straight line groups (sound sources) as an exception.

[Detection by Distance Coefficient Method]

In the two methods described above, only a frequency component present within the range of a predetermined horizontal distance threshold value with respect to straight lines forming a straight line group is selected, and the power and phase of the selected frequency component are directly used as frequency components of a source sound corresponding to the straight line group. On the other hand, in a “distance coefficient method” to be described below, a non-negative coefficient α which monotonously decreases in accordance with an increase in horizontal distance d between a frequency component and straight line is calculated, and the power of this frequency component is multiplied by the non-negative coefficient α. Accordingly, the longer the horizontal distance of a component from a straight line, the weaker the power with which this component contributes to a source sound.

In this method, it is unnecessary to perform any threshold processing using the horizontal distance. That is, a horizontal distance d of each frequency component with respect to a certain straight line group (a horizontal distance to the closest straight line in the straight line group) is obtained, and a value calculated by multiplying the power of the frequency component by a coefficient α which is determined on the basis of the horizontal distance d is used as the power of the frequency component in the straight line group. An expression for calculating the non-negative coefficient α which monotonously decreases in accordance with an increase in horizontal distance d can be any arbitrary expression. An example is sigmoid (S-shaped curve) function α=exp(−(B·d)^{C}) shown in FIG. 25. As shown in FIG. 25, if B is a positive value (1.5 in FIG. 25) and C is a value (2.0 in FIG. 25) larger than 1, α=1 when d=0, and α→0 when d→∞. If the decrease in non-negative coefficient α is abrupt, i.e., if B is large, components outside a straight line group can be easily excluded, and this sharpens the directivity to the direction of a sound source. On the other hand, if the decrease in non-negative coefficient α is moderate, i.e., if B is small, the directivity lowers.

[Processing of Plural FFT Results]

As already described above, the voting unit 303 can perform voting for each FFT and can also collectively vote m (m≧1) consecutive FFT results. Therefore, those functional blocks after the straight line detector 304, which process the Hough voting results operate for each period during which Hough transform is executed once. If Hough voting is performed with m≧2, FFT results at a plurality of times are classified as components of each source sound, so identical frequency components at different times may be caused to revert to different source sounds. To prevent this, regardless of the value of m, the coordinate value determinator 302 gives each frequency component (i.e., a solid circle shown in FIG. 24) the start time of a frame in which this frequency component is acquired, as information of the acquisition time. This makes it possible to refer to which frequency component at which time reverts to which sound source. That is, a source sound is separately extracted as time series data of its frequency component.

[Power Save Option]

In each method described above, for frequency components (only the DC component in the nearest neighbor method, and all frequency components in the distant coefficient method) which belong to a plurality of (N) straight line groups (sound sources), the powers of these frequency components at the same time to be distributed to the individual sound sources can also be normalized and divided into N parts such that the total of these powers is equal to a power value Po(fk) at the same time before the distribution. In this manner, the total power of a whole sound source can be held the same as the input for individual frequency components at the same time. This will be called “power save option”. The method of distribution has the following two ideas:

(1) Division into N equal parts (applicable to the distance threshold method and nearest neighbor method), and (2) distribution corresponding to the distance to each straight line group (applicable to the distance threshold method and distance coefficient method).

(1) is a distribution method which automatically achieves normalization by division into N equal parts. Method (1) is applicable to the distance threshold method and nearest neighbor method each of which determines distribution regardless of the distance.

(2) is a distribution method which saves the total power by determining coefficients in the same manner as in the distance coefficient method, and then normalizing these coefficients such that the total of the coefficients is 1. Method (2) is applicable to the distance threshold method and distance coefficient method in each of which multiple reversion occurs except for the origin.

Note that the sound source component estimator 312 can perform any of the distance threshold method, nearest neighbor method, and distance coefficient method in accordance with the setting. It is also possible to select the power save option described above in the distance threshold method and nearest neighbor method.

[Sound Source Resynthesizer 313]

The sound source resynthesizer 313 performs inverse FFT for frequency components at the same acquisition time which form each source sound, thereby resynthesizing the source sound (amplitude data) in a frame interval whose start time is the acquisition time. As shown in FIG. 3, one frame overlaps the next frame with a time difference corresponding to a frame shift amount between them. In an interval in which a plurality of frames thus overlap each other, the amplitude data of all the overlapping frames can be averaged into final amplitude data. By this processing, a source sound can be separately extracted as its amplitude data.

[Time Series Tracking Unit 314]

As described above, the straight line detector 304 obtains a straight line group whenever the voting unit 303 performs Hough voting. Hough voting is performed once for m (m≧1) consecutive FFT results. As a consequence, a straight line group is obtained in a time series manner at a period (to be referred to as a “figure detection period” hereinafter) which is the time of m frames. Also, θ of a straight line group is obtained in one-to-one correspondence with the sound source direction φ calculated by the direction estimator 305. Therefore, regardless of whether a sound source is standing still or moving, the locus on the time axis of θ (or φ) corresponding to a stable sound source is presumably continuous. On the other hand, depending on the setting of a threshold value, straight line groups detected by the straight line detector 304 sometimes include a straight line group (to be referred to as a “noise straight line group” hereinafter) corresponding to background noise. However, the locus on the time axis of θ (or φ) of this noise straight line group is expected to be discontinuous, or short even though it is continuous.

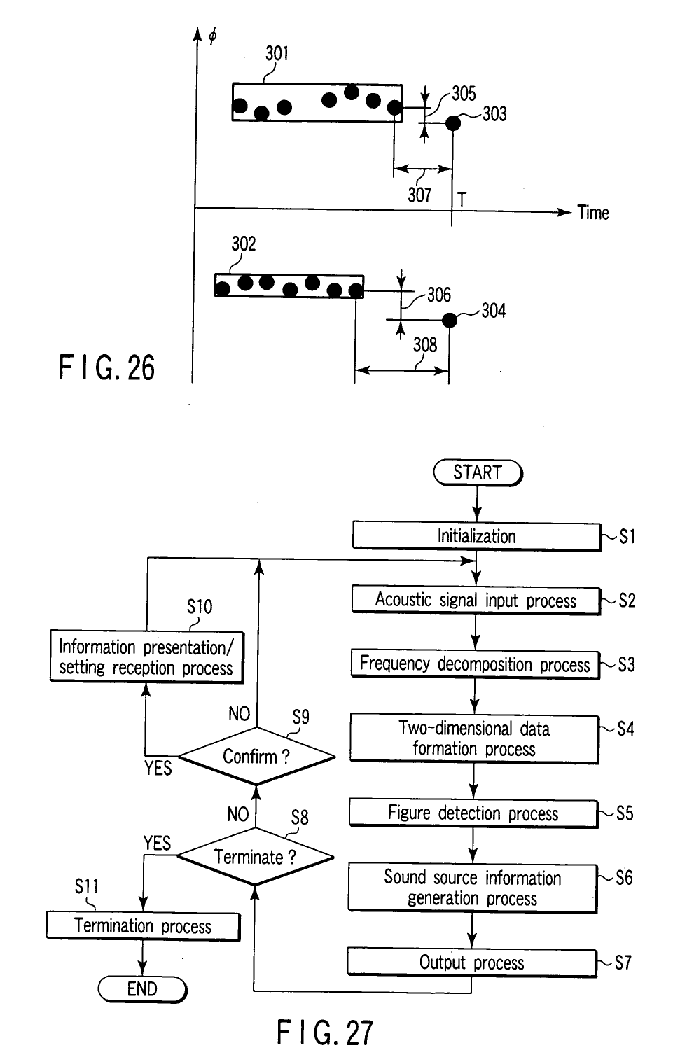

The time series tracking unit 314 is a means for diving φ thus obtained for each figure detection period into groups which continue on the time axis, thereby obtaining the locus of φ on the time axis. The method of division into groups will be explained below with reference to FIG. 26.

(1) A locus data buffer is prepared. This locus data buffer is an array of locus data. One locus data Kd can hold start time Ts, end time Te, an array (straight line group list) of straight line group data Ld which forms the locus, and a label number Ln. One straight line group data Ld is a data group including the θ value and ρ value (obtained by the straight line detector 304) of one straight line group forming the locus, the φ value (obtained by the direction estimator 311) representing the sound source direction corresponding to this straight line group, frequency components (obtained by the sound source component estimator 312) corresponding to the straight line group, and the acquisition time of these frequency components. Note that the locus data buffer is initially empty. Note also that a new label number is prepared as a parameter for issuing a label number, and the initial value of this new label number is set to 0.

(2) At certain time T, for each newly obtained φ (to be referred to as φn hereinafter; in FIG. 26, two φn's indicated by solid circles 303 and 304 are obtained), the straight line group data Ld (solid circles arranged in each rectangle in FIG. 26) of the locus data Kd (a rectangle 301 or 302 in FIG. 26) held in the locus data buffer is referred to, thereby detecting locus data having Ld in which the difference (305 or 306 in FIG. 26) between the φ value and φn is equal to or smaller than a predetermined angular threshold value Δφ, and the difference (307 or 308 in FIG. 26) between the acquisition times is equal to or smaller than a predetermined time threshold value Δt. Consequently, locus data 301 is detected for the solid circle 303. For the solid circle 304, however, even closest locus data 302 does not satisfy the above conditions.

(3) If locus data which satisfies the conditions of (2) is found as in the case of the solid circle 303, it is determined that φn forms the same locus as this locus, so this φn and a θ value, ρ value, frequency component, and present time T corresponding to φn are added as new straight line group data of the locus Kd to the straight line group list, and the present time T is set as new end time Te of the locus. If a plurality of loci are found, it is determined that all these loci form the same locus, so these loci are integrated into locus data having the smallest label number, and the rest are deleted from the locus data buffer. The start time Ts of the integrated locus data is the earliest start time of the individual locus data before the integration, the end time Te of the integrated locus data is the latest end time of the individual locus data before the integration, and the straight line group list is the union of straight line group lists of the individual locus data before the integration. As a consequence, the solid circle 303 is added to the locus data 301.

(4) If no locus data which satisfies the conditions of (2) is found as in the case of the solid circle 304, it is determined that a new locus begins, so new locus data is formed in an empty area of the locus data buffer. In addition, both the start time Ts and end time Te are set at the present time T, φn and a θ value, φ value, frequency component, and present time T corresponding to φn are set as first straight line group data in the straight line group list, the value of a new label number is given as the label number Ln of this locus, and the new label number is increased by 1. Note that if the new label number has reached a predetermined maximum value, it is returned to 0. Consequently, the solid circle 304 is registered as new locus data in the locus data buffer.

(5) If the predetermined time Δt described above has elapsed for locus data held in the locus data buffer after the locus data is last updated (i.e., after the end time Te of the locus data) and before the present time T, it is determined that this locus data is a locus for which no new φn to be added is found, i.e., this locus data is a completely tracked locus. Therefore, after being output to the continuation time evaluator 315 in the next stage, this locus data is deleted from the locus data buffer. Referring to FIG. 26, the locus data 302 is this locus data.

[Continuation Time Evaluator 315]

The continuation time evaluator 315 calculates the continuation time of a locus represented by completely tracked locus data output from the time series tracking unit 314, on the basis of the start time and end time of the locus data. If this continuation time exceeds a predetermined threshold value, the continuation time evaluator 315 determines that the locus data is based on a source sound; if not, the continuation time evaluation 315 determines that the locus data is based on noise. Locus data based on a source sound will be called sound source stream information hereinafter. This sound source stream information contains the start time Ts and end time Te of the source sound, and time series locus data of θ, ρ, and φ representing the sound source direction. Note that the number of straight line groups obtained by the figure detector 5 gives the number of sound sources, but this number includes noise sources. The number of pieces of sound source stream information obtained by the continuation time evaluator 315 gives the number of reliable sound sources except for those based on noise.

[Phase Matching Unit 316]

The phase matching unit 316 refers to sound source stream information obtained by the time series tracking unit 314, and obtains the time transition of the stream in the sound source direction φ. On the basis of a maximum value φmax and minimum value φmin of φ, the phase matching unit 316 calculates intermediate value φmid=(φmax+φmin)/2 to obtain width φw=φmax −φmid. Then, the phase matching unit 316 extracts the time series data of the two frequency-decomposed data sets a and b as the basis of the sound source stream information, from the time which is earlier by a predetermined time than the start time Ts of the stream to the time which is later by a predetermined time than the end time Te. The phase matching unit 316 matches the phases of these time series data by correcting them such that the arrival time difference calculated by a reverse operation by using the intermediate value φmid is canceled.

It is also possible to always match the phases of the time series data of the two frequency-decomposed data by using the sound source direction φ at each time obtained by the direction estimator 311 as φmid. Whether to refer to sound source stream information or φ at each time is determined by the operation mode, and this operation mode can be set and changed as a parameter.

[Adaptive Array Processor 317]

Adaptive array processing points its central directivity to front 0°, and has a value obtained by adding a predetermined margin to ±φw a tracking range. The adaptive array processor 317 performs this adaptive array processing for those time series data of the two frequency-decomposed data sets a and b, which are extracted and made in phase with each other, thereby accurately separating and extracting the time series data of frequency components of a source sound of this stream. Although the methods are different, this processing functions in the same manner as the sound source component estimator 312 in that the time series data of frequency components are separately extracted. Therefore, the source sound resynthesizer 313 can also resynthesize the amplitude data of a source sound from the time series data of frequency components of the source sound obtained by the adaptive array processor 317.

Note that as the adaptive array processing, it is possible to use a method which clearly separates and extracts sounds within a set directivity range by using a “Griffith-Jim type generalized side lob canceller” known as a beam former formation method, as each of two, main and sub cancellers, as described in reference 3 “Tadashi Amada et al., “Microphone Array Technique for Voice Recognition”, Toshiba Review 2004, Vol. 59, No. 9, 2004”.

The adaptive array processing is normally used to receive sounds only in the direction of a preset tracking range. Therefore, it is necessary to prepare a large number of adaptive arrays having different tracking ranges, in order to receive sounds in all directions. In this embodiment, however, after the number and directions of sound sources are actually obtained, only adaptive arrays equal in number to the sound sources can be operated. Since the tracking range can also be set within a predetermined narrow range corresponding to the directions of the sound sources, data can be efficiently separated and extracted with high quality.

Also, since the phases of the time series data of the two frequency-decomposed data sets a an b are matched beforehand, sounds in all directions can be processed only by setting the tracking range of the adaptive array processing near the front.

[Voice Recognition Unit 318]

The voice recognition unit 318 analyzes and collates the time series data of frequency components of a source sound extracted by the sound source component estimator 312 or adaptive array processor 317, thereby extracting the symbolic contents of the stream, i.e., extracting a symbol (sequence) representing the language meaning, the type of sound source, or the identity of a speaker.

Note that the functional blocks from the direction estimator 311 to the voice recognition unit 318 can exchange information by connections not shown in FIG. 20 where necessary.

[Output Unit 7]

The output unit 7 is a means for outputting, as the sound source information obtained by the sound source information generator 6, information containing at least one of the number of sound sources obtained as the number of straight line groups by the figure detector 5, that spatial existing range (the angle φ which determines a circular cone) of each sound source as an acoustic signal generation source, which is estimated by the direction estimator 311, that components (the time series data of the power and phase of each frequency component) of a sound generated by each sound source, which is estimated by the sound source component estimator 312, that separated sound (the time series data of an amplitude value) separated for each sound source, which is synthesized by the source sound resynthesizer 313, that number of sound sources except for noise sources, which is determined on the basis of the time series tracking unit 314 and continuation time evaluator 315, that temporal existing period of a sound generated by each sound source, which is determined by the time series tracking unit 314 and continuation time evaluator 315, that separated sound (the time series data of an amplitude value) of each sound source, which is obtained by the phase matching unit 316 and adaptive array processor 317, and those symbolic contents of each source sound, which are obtained by the voice recognition unit 318.

[User Interface Unit 8]

The user interface unit 8 is a means for presenting, to the user, various set contents necessary for the acoustic signal processing described above, receiving settings input by the user, saving the set contents in an external storage device, reading out the set contents from the external storage device, and presenting, to the user, various processing results and intermediate results by visualizing them. For example, the user interface unit 8 (1) displays frequency components of each microphone, (2) displays a phase difference (or time difference) plot (i.e., displays two-dimensional data), (3) displays various vote distributions, (4) displays peak positions, and (5) displays straight line groups on the plot as shown in FIG. 17 or 19, (6) displays frequency components which revert to a straight line group as shown in FIG. 23 or 24, and (7) displays locus data as shown in FIG. 26. The user interface unit 8 is also a means for allowing the user to select desired data, and visualizing the selected data in detail. The user interface unit 8 allows the user to, e.g., check the operation of the acoustic signal processing apparatus according to this embodiment, adjust the apparatus to be able to perform a desired operation, and use the apparatus in this adjusted state after that.

[Flowchart of Processing]

FIG. 27 is a flowchart showing the flow of processing executed by the acoustic signal processing apparatus according to this embodiment. This processing comprises initialization step S1, acoustic signal input step S2, frequency decomposition step S3, two-dimensional data formation step S4, figure detection step S5, sound source information generation step S6, output step S7, termination determination step S8, confirmation determination step S9, information presentation/setting reception step S10, and termination step S11.

Initialization step S1 is a processing step of executing a part of the processing of the user interface unit 8 described above. In this step, various set contents necessary for the acoustic signal processing are read out from an external storage device to initialize the apparatus into a predetermined set state.

Acoustic signal input step S2 is a processing step of executing the processing of the acoustic signal input unit 2 described above. In this step, two acoustic signals picked up in two spatially different positions are input.

Frequency decomposition step S3 is a processing step of executing the processing of the frequency decomposer 3 described above. In this step, each of the acoustic signals input in acoustic signal input step S2 is decomposed into frequency components, and at least a phase value (and a power value if necessary) of each frequency is calculated.

Two-dimensional data formation step S4 is a processing step of executing the processing of the two-dimensional data formation unit 4 described above. In this step, those phase values of the individual frequencies of the input acoustic signals, which are calculated in frequency decomposition step S3 are compared to calculate a phase difference value of each frequency of the two signals. This phase difference value of each frequency is converted into (x, y) coordinate values uniquely determined by the frequency and its phase difference as a point on an X-Y coordinate system in which the function of the frequency is the Y axis and the function of the phase difference value is the X axis.

Figure detection step S5 is a processing step of executing the processing of the figure detector 5 described above. In this step, a predetermined figure is detected from the two-dimensional data formed in two-dimensional data formation step S4.

Sound source signal generation step S6 is a processing step of executing the processing of the sound source information generator 6 described above. In this step, sound source information is generated on the basis of the information of the figure detected in figure detection step S5. This sound source information contains at least one of the number of sound sources as generation sources of the acoustic signals, the spatial existing range of each sound source, the components of the sound generated by each sound source, the separated sound of each sound source, the temporal existing period of the sound generated by each sound source, and the symbolic contents of the sound generated by each sound source.

Output step S7 is a processing step of executing the processing of the output unit 7 described above. In this step, the sound source information generated in sound source information generation step S6 is output.

Termination determination step S8 is a processing step of executing a part of the processing of the user interface unit 8. In this step, the presence/absence of a termination instruction from the user is checked. If a termination instruction is present, the flow advances to termination step S11 (branches to the left). If no termination instruction is present, the flow advances to confirmation determination step S9 (branches upward).

Confirmation determination step S9 is a processing step of executing a part of the processing of the user interface unit 8. In this step, the presence/absence of a confirmation instruction from the user is checked. If a confirmation instruction is present, the flow advances to information presentation/setting reception step S10 (branches to the left). If no confirmation instruction is present, the flow returns to acoustic signal input step S2 (branches upward).

Information presentation/setting reception step S10 is a processing step of executing a part of the processing of the user interface unit 8 in response to the confirmation instruction from the user. In this step, various set contents necessary for the acoustic signal processing are presented to the user, settings input by the user are received, the set contents are saved in an external storage device by a save instruction, the set contents are read out from the external storage device by a read instruction, various processing results and intermediate results are visualized and presented to the user, and desired data is selected by the user and visualized in detail. In this manner, the user can check the operation of the acoustic signal processing, adjust the processing to be able to perform a desired operation, and continue the processing in the adjusted state after that.

Termination step S11 is a processing step of executing a part of the processing of the user interface unit 8 in response to the termination instruction from the user. In this step, various set contents necessary for the acoustic signal processing are automatically saved in an external storage device.

[Modifications]

Modifications of the above embodiment will be explained below.

[Detection of Vertical Line]

As shown in FIG. 7, the coordinate value determinator 302 of the two-dimensional data formation unit 4 generates dots by using X-coordinate values as the phase difference ΔPh(fk) and Y-coordinate values as the frequency component number k. The X-coordinate value may also be estimation value ΔT(fk)=(ΔPh(fk)/2π)×(1/fk) of the arrival time difference calculated for each frequency from the phase difference ΔPh(fk). When the arrival time difference is used instead of the phase difference, dots having the same arrival time, i.e., derived from the same sound source are arranged on a vertical straight line.

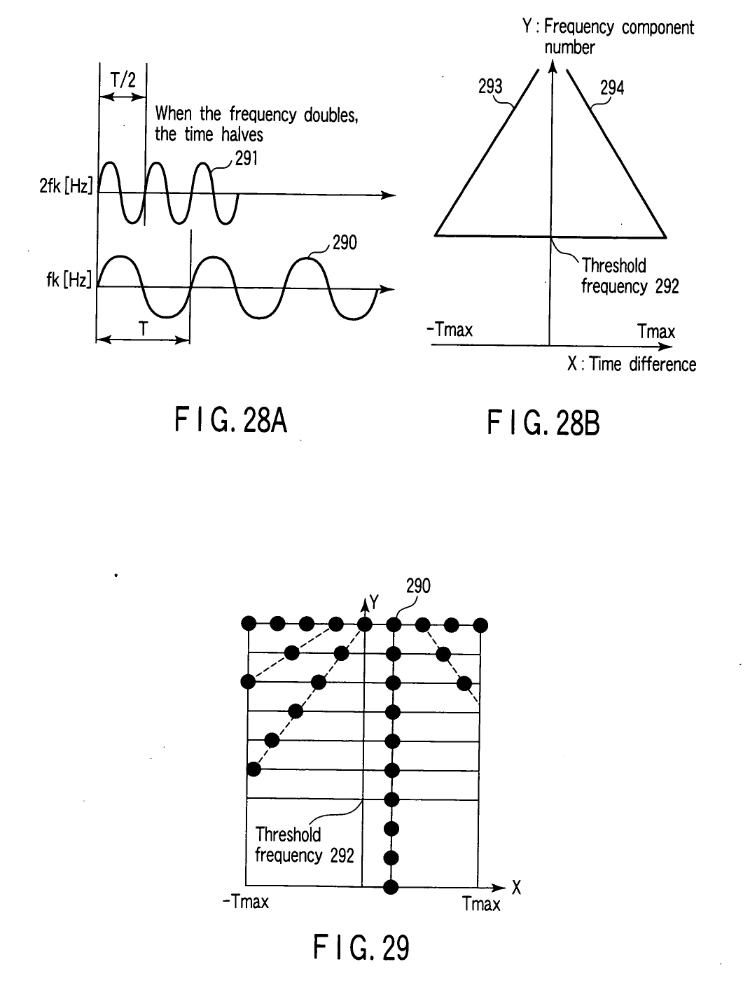

In this case, the higher the frequency, the smaller the time difference ΔT(fk) which can be expressed by ΔPh(fk). As schematically shown in FIG. 28A, letting T be a time represented by one period of a wave 290 having a frequency fk, a time which can be represented by one period of a wave 291 of a double frequency 2fk is T/2. When the time difference is plotted on the X axis as shown in FIG. 28A, the range of the time difference is ±Tmax, and no time difference is observed outside this range. At a low frequency equal to or lower than a threshold frequency 292 at which Tmax is a ½ period (i.e., π) or less, the arrival time difference ΔT(fk) is uniquely obtained from the phase difference ΔPh(fk). However, at a high frequency exceeding the threshold frequency 292, the calculated ΔT(fk) is smaller than theoretically possible Tmax. As shown in FIG. 28B, therefore, only a range between straight lines 293 and 294 can be expressed. This is the same problem as the phase difference circularity problem described previously.

To solve this phase difference circularity problem, therefore, as schematically shown in FIG. 29, for a frequency region exceeding the threshold frequency 292, the coordinate value determinator 302 generates, within the range of ±Tmax, redundant points in the position of ΔT corresponding to the phase difference by adding or subtracting, e.g., 2π, 4π, or 6π with respect to one ΔP(fk), thereby forming two-dimensional data. The generated points are solid circles shown in FIG. 29. In the frequency region exceeding the threshold frequency 292, a plurality of solid circles are plotted for one frequency.

In this case, on the basis of the two-dimensional data generated as one or a plurality of points with respect to one phase difference value, the voting unit 303 and straight line detector 304 can detect a powerful vertical line (295 in FIG. 29) by Hough voting. Since this vertical line is a straight line by which θ=0 in the Hough voting space, the problem of detecting a vertical line can be solved by detecting a peak position having the number of votes equal to or larger than a predetermined threshold value on the ρ axis by which θ=0 in a vote distribution after Hough voting. The ρ value of the detected peak position gives the intersection of the vertical line and X axis, i.e., an estimation value of the arrival time difference ΔT. Note that the voting conditions and addition methods described in the explanation of the voting unit 303 can be directly used in voting. Note also that a straight line corresponding to a sound source is not a straight line group but a single vertical line.

This problem of obtaining the peak position can also be solved by detecting a peak position having the number of votes equal to or larger than the predetermined threshold value, in a one-dimensional vote distribution (a peripheral distribution projectively voted in the Y-axis direction) in which the X-coordinate values of the above-mentioned redundant points are voted. When the arrival time difference is thus used as the X axis instead of the phase difference, all evidences representing sound sources present in different directions are projected on straight lines having the same inclination (i.e., on vertical lines). This allows easy detection by the peripheral distribution without any Hough transform.

Information of the sound source direction obtained by the vertical line is the arrival time difference ΔT obtained as ρ rather than θ. Accordingly, the direction estimator 311 can immediately calculate the sound source direction φ from ΔT without using θ.

As described above, the two-dimensional data formed by the two-dimensional data formation unit 4 is not limited to one type, and the figure detection method of the figure detector 5 is also not limited to one type. Note that the plot of points using the arrival time difference and the detected vertical line shown in FIG. 29 are also information to be presented to the user by the user interface unit 8.

[Parallel Arrangement of Plural Systems]

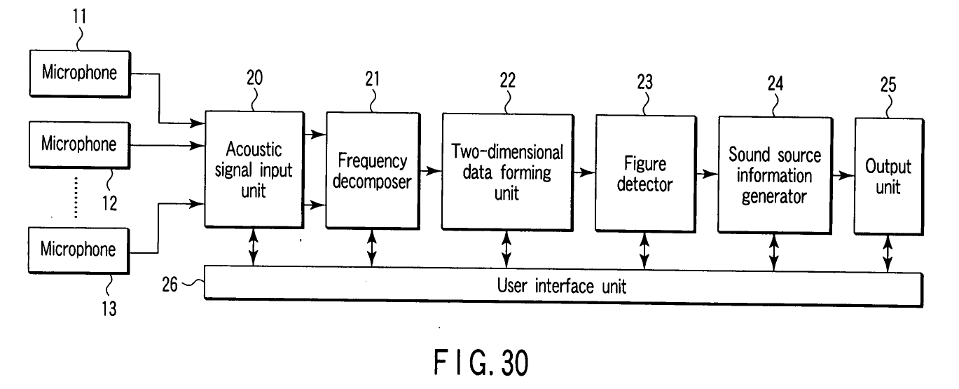

The above embodiment is explained by the simplest arrangement including two microphones. As shown in FIG. 30, however, it is also possible to arrange a maximum of M (1≦M≦_{N}C₂) microphone pairs by using N (N≧3) microphones.

In FIG. 30, reference numerals 11 to 13 denote the N microphones; 20, a means for inputting N acoustic signals obtained by the N microphones; 21, a means for decomposing the frequencies of the input N acoustic signals; 22, a means for generating two-dimensional data for each of M (1≦M≦_{N}C₂) pairs of the N acoustic signals; 23, a means for detecting a predetermined figure from each of the M two-dimensional data pairs generated; 24, a means for generating sound source information from each of the M pairs of figure information detected; 25, a means for outputting the generated sound source information; and 26, a means for presenting, to the user, various set values including information of the microphones forming each pair, receiving settings input by the user, saving the set values in an external storage device, reading out the set values from the external storage device, and presenting various processing results to the user. Processing for each microphone pair is the same as in the above embodiment, and the processing is executed in parallel for a plurality of microphone pairs.

In this arrangement, although one microphone pair cannot cover all directions, the possibility that no correct sound source information is obtained can be reduced, by covering all directions by a plurality of microphone pairs.

[Implementation Using General-Purpose Computer: Program]

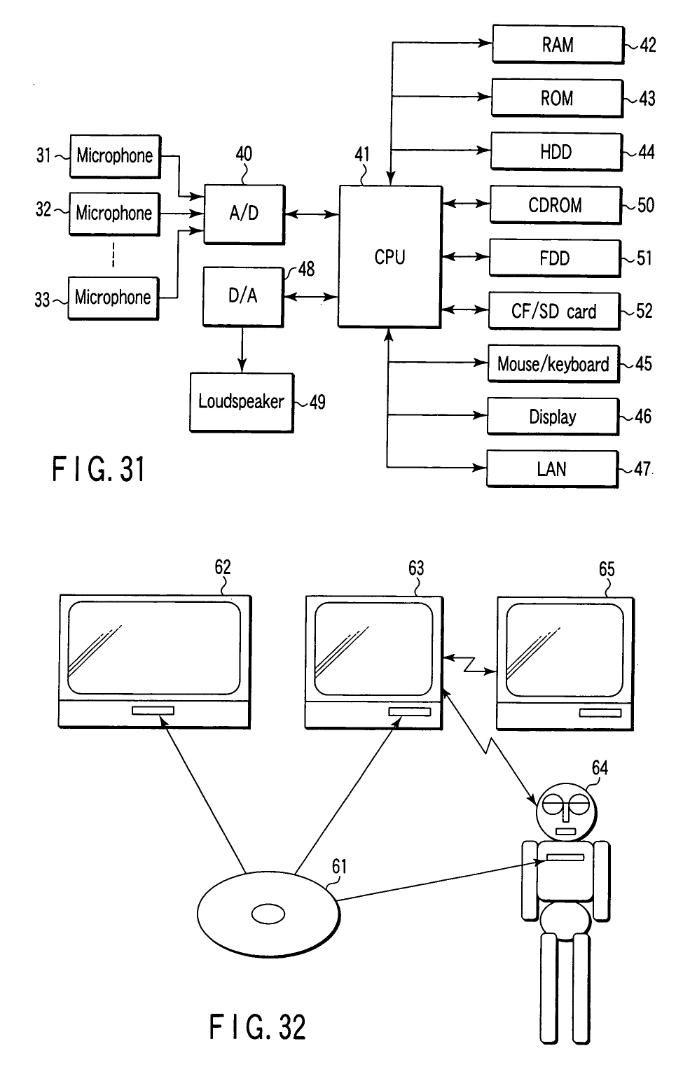

As shown in FIG. 31, this embodiment according to the present invention may also be practiced as a general-purpose computer capable of executing a program for implementing the acoustic signal processing function according to the present invention. In FIG. 31, reference numerals 31 to 33 denote N microphones; 40, an A/D-converting means for inputting N acoustic signals obtained by N microphones; 41, a CPU which executes program instructions for processing the input N acoustic signals; and 42 to 47, standard devices forming the computer, i.e., a RAM 42, ROM 43, HDD 44, mouse/keyboard 45, display 46, and LAN 47. Reference numerals 50 to 52 denote drives, i.e., a CDROM 50, FDD 51, and CF/SD card 52, for supplying programs and data to the computer from the outside via storage media; 48, a D/A-converting means for outputting acoustic signals; and 49, a loudspeaker connected to the output terminal of the D/A-converting means 48. This computer apparatus functions as an acoustic signal processing apparatus by storing an acoustic signal processing program for executing the processing steps shown in FIG. 27, reading out the program to the RAM 42, and executing the program by the CPU 41. The computer apparatus also implements the functions of the user interface unit 8 described above by using the HDD 44 as an external storage device, the mouse/keyboard 45 for accepting input operations, and the display 46 and loudspeaker 49 as information presenting means. Furthermore, the computer apparatus saves sound source information obtained by the acoustic signal processing into the RAM 42, ROM 43, and HDD 44, or outputs the information by communication via the LAN 47.

[Recording Medium]

As shown in FIG. 32, it is also possible to practice the present invention as a computer-readable recording medium. In FIG. 32, reference numeral 61 denotes a recording medium implemented by a CD-ROM, CF or SD card, or floppy disk which records the acoustic signal processing program according to the present invention. This program can be executed by inserting the recording medium 61 into an electronic apparatus 62 or 63 such as a television set or computer, or into a robot 64. The program can also be executed on another electronic apparatus 65 or the robot 64 by supplying the program to the electronic apparatus 65 or robot 64 by communication from the electronic apparatus 63 to which the program is supplied.

[Correction of Sonic Velocity by Temperature Sensor]

The present invention may also be practiced by attaching a temperature sensor for measuring the atmospheric temperature to the apparatus, and correcting the sonic velocity Vs shown in FIG. 22 on the basis of the temperature data measured by the temperature sensor, thereby obtaining accurate Tmax.

Alternatively, the present invention can be practiced by attaching to the apparatus a sound wave transmitting means and receiving means spaced at a predetermined interval, and measuring a time required for a sound wave generated by the transmitting means to reach the receiving means by using a measuring means, thereby directly calculating and correcting the sonic velocity Vs, and obtaining accurate Tmax.

[Make Intervals of θ Unequal to Obtain Equal Intervals of φ]

In the present invention, when Hough transform is to be executed to obtain the inclination of a straight line group, θ is quantized for, e.g., every 1°. However, when θ is thus quantized at equal intervals, the value of the sound source direction φ which can be estimated is quantized at unequal intervals. To prevent this, the present invention may also be practiced such that the estimation accuracy in the sound source direction does not easily vary, by quantizing θ so that φ is quantized at equal intervals.

The method described in Kazuhiro Nakadai et al., “Real-time Active Person Tracking by Hierarchical Integration of Audiovisual Information”, Artificial Intelligence Society AI Challenge Research Meeting, SIG-Challenge-0113-5, pp. 35-42, June 2001 estimates the number, directions, and components of sound sources by detecting a fundamental frequency component and its harmonic components forming a harmonic structure from frequency-decomposed data. Since the harmonic structure is assumed, this method is specialized to human voices. In actual environments, however, many sound sources having no harmonic structure, e.g., the sounds of opening and closure of doors exist. This method cannot process such source sounds.

Also, the method described in Futoshi Asano, “Separating Sounds”, Measurement and Control, Vol. 43, No. 4, pp. 325-330, April 2004 is not limited to any specific model. However, as long as two microphones are used, the number of sound sources which can be processed is limited to one.

On the other hand, the embodiment of the present invention can implement the function of localizing and separating two or more sound sources by using two microphones by dividing the phase differences of frequency components into groups of individual sound sources by Hough transform. Since no such limiting model as a harmonic structure is used, the present invention is applicable to sound sources having various properties.

The other functions and effects achieved by the embodiment of the present invention will be summarized below.

Various types of sound sources can be stably detected by using, when Hough voting is performed, a voting method suited to detecting a sound source having many frequency components or a powerful sound source.

Sound sources can be efficiently and accurately detected by imposing limitation ρ=0 and taking phase difference circularity into consideration during straight line detection.

It is possible by using straight line detection results to obtain useful sound source information containing the spatial existing range of a sound source as a generation source of an acoustic signal, the temporal existing period of a source sound generated by the sound source, the components of the source sound, a separated sound of the source sound, and the symbolic contents of the source sound.

When frequency components of individual source sounds are to be estimated, these source sounds can be easily separated by simply selecting components near straight lines, determining which component reverts to which straight line, and performing coefficient multiplication corresponding to the distance between each straight line and component.

Sound sources can be separated more accurately by adaptively setting the directivity range of adaptive array processing by detecting the direction of each sound source beforehand.

The symbolic contents of each source sound can be determined by accurately separating and recognizing the source sound.

The user can check the operation of this apparatus, adjust the apparatus to be able to perform a desired operation, and use the apparatus in the adjusted state after that.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An acoustic signal processing apparatus comprising:
an acoustic signal input device to input a plurality of acoustic signals picked up at not less than two points which are not spatially identical;
a frequency decomposing device configured to decompose each of said plurality of acoustic signals to obtain a plurality of frequency-decomposed data sets representing a phase value of each frequency;
a phase difference calculating device configured to calculate a phase difference value of each frequency for a pair of different ones of said plurality of frequency-decomposed data sets;
a two-dimensional data forming device configured to generate, for each pair, two-dimensional data representing dots having coordinate values on a two-dimensional coordinate system in which a function of the frequency is a first axis and a function of the phase difference value calculated by the phase difference calculating device is a second axis;
a figure detecting device configured to detect, from the two-dimensional data, a figure which reflects a proportional relationship between a frequency and phase difference derived from the same sound source;
a sound source information generating device configured to generate, on the basis of the figure, sound source information which contains at least one of the number of sound sources corresponding to generation sources of the acoustic signals, a spatial existing range of each sound source, a temporal existing period of a sound generated by each sound source, components of a sound generated by each sound source, a separated sound separated for each sound source, and symbolic contents of a sound generated by each sound source, and which relates to sound sources distinguished from each other; and
an output device to output the sound source information.

2. An apparatus according to claim 1, wherein the two-dimensional data forming device includes a coordinate value determining device configured to determine coordinate values on a two-dimensional coordinate system in which a scalar multiple of the frequency is the first axis, and a scalar multiple of the phase difference value is the second axis.

3. An apparatus according to claim 1, wherein the two-dimensional data forming device includes a coordinate value determining device configured to determine coordinate values on a two-dimensional coordinate system in which a function of the frequency is the first axis, and a function which calculates an arrival time difference from the phase difference value calculated by the phase difference value calculating device is the second axis.

4. An apparatus according to claim 2, wherein the figure detecting device includes:
a voting device configured to generate a vote distribution by voting points having coordinate values determined by the coordinate value determining device in a voting space by linear Hough transform; and
a straight line detecting device configured to detect a straight line from the vote distribution generated by the voting device, by detecting, in a descending order of vote, a predetermined number of peak positions each having the number of votes not less than a threshold value.

5. An apparatus according to claim 3, wherein the figure detecting device includes:
a voting device configured to vote points having coordinate values determined by the coordinate value determining device in a voting space projected in a predetermined direction, thereby generating a vote distribution which is a projectively voted peripheral distribution; and
a straight line detecting device configured to detect a straight line from the vote distribution generated by the voting device, by detecting, in a descending order of vote, a predetermined number of peak positions each having the number of votes not less than a predetermined threshold value.

6. An apparatus according to claim 4, wherein
the voting device votes a fixed value in the voting space, and
the straight line detecting device detects a straight line passing many points of each frequency in the two-dimensional coordinate system.

7. An apparatus according to claim 4, wherein the frequency decomposing device calculates not only the phase value of each frequency but also a power value of each frequency,
the voting device votes a numerical value based on the power value, and
the straight line detecting device detects a straight line passing many powerful points of each frequency in the two-dimensional coordinate system.

8. An apparatus according to claim 4, wherein when detecting a peak position having the number of votes not less than a predetermined threshold value from the vote distribution, the straight line detecting device obtains the peak position only for a position, in the voting space, which corresponds to a straight line passing through a specific position on the two-dimensional coordinate system.

9. An apparatus according to claim 4, wherein when detecting a peak position having the number of votes not less than a predetermined threshold value from the vote distribution, the straight line detecting device calculates a total of votes which correspond to parallel straight lines having the same inclination as the straight line detected by the straight line detecting device, and which are separated by a predetermined distance calculated in accordance with the inclination.

10. An apparatus according to claim 4, wherein the sound source information generating device includes a direction estimating device configured to calculate the spatial existing range of a sound source as an angle with respect to a line segment which connects two points at which the acoustic signals are picked up, on the basis of the inclination of the straight line detected by the straight line detecting device, or on the basis of an intersection of the straight line detected by the straight line detecting device and the second axis.

11. An apparatus according to claim 4, wherein the sound source information generating device includes a sound source component estimating device configured to calculate, for each frequency, a distance between the coordinate value and a straight line detected by the straight line detecting device, and, on the basis of the distance, estimate a frequency component of a sound generated by a sound source corresponding to the straight line.

12. An apparatus according to claim 4, wherein the sound source information generating device includes:
a sound source component estimating device configured to calculate, for each frequency, a distance between the coordinate value and a straight line detected by the straight line detecting device, and, on the basis of the distance, estimate a frequency component of a sound generated by a sound source corresponding to the straight line; and
a separated sound extracting device configured to synthesize acoustic signal data generated by the sound source from the estimated frequency component of the sound.

13. An apparatus according to claim 11, wherein the sound source component estimating device determines that a frequency by which a distance of the coordinate value from the straight line is not more than a predetermined threshold value is a frequency component of a sound generated by a sound source corresponding to the straight line.

14. An apparatus according to claim 11, wherein the sound source component estimating device determines that a frequency by which a distance of the coordinate value from the straight line is not more than a predetermined threshold value is a candidate of a frequency component of a sound generated by a sound source corresponding to the straight line, and causes the frequency to revert to a closest straight line for the same frequency component.

15. An apparatus according to claim 11, wherein
the frequency decomposing device calculates not only the phase value of each frequency but also a power value of each frequency, and
the sound source component estimating device calculates a non-negative coefficient which monotonously decreases in accordance with an increase in distance of the coordinate value to the straight line, and determines that a value obtained by multiplying the power of a frequency by the non-negative coefficient is a power value of the frequency component of a sound generated by a sound source corresponding to the straight line.

16. An apparatus according to claim 4, wherein the sound source information generating device includes:
a direction estimating device configured to calculate the spatial existing range of a sound source as an angle with respect to a line segment which connects two points at which the acoustic signals are picked up, on the basis of the inclination of the straight line detected by the straight line detecting device, or on the basis of an intersection of the straight line detected by the straight line detecting device and the second axis; and
an adaptive array processing device configured to set a tracking range pertaining to a sound source direction on the basis of the angle, and allow only a sound from a sound source existing in the tracking range to pass through, thereby extracting data of an acoustic signal of a sound generated by the sound source.

17. An apparatus according to claim 1, further comprising a user interface device configured to cause a user to check and change setting information pertaining to an operation of the apparatus.

18. An apparatus according to claim 1, further comprising a user interface device configured to cause a user to save and read out setting information pertaining to an operation of the apparatus.

19. An apparatus according to claim 1, further comprising a user interface device configured to present the two-dimensional data or the figure to a user.

20. An apparatus according to claim 1, further comprising a user interface device configured to present the sound source information to a user.

21. An apparatus according to claim 1, wherein the figure detecting device detects the figure from a three-dimensional data set which is a time series of the two-dimensional data set.

22. An acoustic signal processing method comprising:
inputting a plurality of acoustic signals picked up at not less than two points which are not spatially identical;
decomposing each of the plurality of acoustic signals to obtain a plurality of frequency-decomposed data sets representing a phase value of each frequency;
calculating a phase difference value of each frequency for a pair of different ones of the plurality of frequency-decomposed data sets;
generating, for each pair, two-dimensional data representing dots having coordinate values on a two-dimensional coordinate system in which a function of the frequency is a first axis and a function of the calculated phase difference value is a second axis;
detecting, from the two-dimensional data, a figure which reflects a proportional relationship between a frequency and phase difference derived from the same sound source;
generating, on the basis of the figure, sound source information which contains at least one of the number of sound sources corresponding to generation sources of the acoustic signals, a spatial existing range of each sound source, a temporal existing period of a sound generated by each sound source, components of a sound generated by each sound source, a separated sound separated for each sound source, and symbolic contents of a sound generated by each sound source, and which relates to sound sources distinguished from each other; and
outputting the sound source information.

23. An acoustic signal processing program recorded on a computer readable storage medium, the program comprising:
means for instructing a computer to input a plurality of acoustic signals picked up at not less than two points which are not spatially identical;
means for instructing the computer to decompose each of the plurality of acoustic signals to obtain a plurality of frequency-decomposed data sets representing a phase value of each frequency;
means for instructing the computer to calculate a phase difference value of each frequency for a pair of different ones of the plurality of frequency-decomposed data sets;
means for instructing the computer to generate, for each pair, two-dimensional data representing dots having coordinate values on a two-dimensional coordinate system in which a function of the frequency is a first axis and a function of the phase difference value calculated by the phase difference calculation sequence is a second axis;
means for instructing the computer to detect, from the two-dimensional data, a figure which reflects a proportional relationship between a frequency and phase difference derived from the same sound source;
means for instructing the computer to generate, on the basis of the figure, sound source information which contains at least one of the number of sound sources corresponding to generation sources of the acoustic signals, a spatial existing range of each sound source, a temporal existing period of a sound generated by each sound source, components of a sound generated by each sound source, a separated sound separated for each sound source, and symbolic contents of a sound generated by each sound source, and which relates to sound sources distinguished from each other; and
means for instructing the computer to output the sound source information.

24. A computer-readable recording medium recording an acoustic signal processing program recited in claim 23.
